(19) United States
(12) Patent Application Publication
(10) Pub. No.: US 2017/0185836 A1
(43) Pub. Date: Jun. 29, 2017

(54) MARKING ANALYSIS SYSTEM AND MARKING ANALYSIS METHOD

(71) Applicant: RENESAS ELECTRONICS CORPORATION, Tokyo (JP)

(72) Inventors: Shunsuke OKUMURA, Tokyo (JP); Koichi NOSE, Tokyo (JP); Kenichiro HIJIOKA, Tokyo (JP)

(21) Appl. No.: 15/383,304

(22) Filed: Dec. 19, 2016

(30) Foreign Application Priority Data
Dec. 25, 2015 (JP) 2015-253699

(51) Int. Cl. G06K 9/00; H04N 1/107; G06K 9/66; G06T 7/70; G06K 9/62

(52) U.S. Cl. CPC G06K 9/00483; G06T 7/70; G06K 9/6215; G06K 9/66; H04N 1/107; G06T 2207/30204; H04N 2201/3245; H04N 2201/0081; H04N 2201/0096; H04N 2201/0434

(57) ABSTRACT

A marking analysis system includes a marking data storage unit to store a plurality of marking data indicating a plurality of positions marked by a user in a book so as to correspond respectively to a plurality of users, a marking distribution analysis unit that analyzes the marking data and calculates a marking frequency for each of a plurality of unit areas in the book, and generates marking distribution characteristic data indicating a distribution of the marking frequency with respect to a position in the unit area, a marking distribution characteristic data storage unit to store the marking distribution characteristic data, and a similar user retrieval unit that, when determining that the distribution of the marking frequency indicated by the marking distribution characteristic data of a target user selected as a processing target and the distribution of the marking frequency indicated by the marking distribution characteristic data of another user are similar, extracts the another user as a similar user who is similar to the target user.

### CROSS-REFERENCE TO RELATED APPLICATIONS

This application is based upon and claims the benefit of priority from Japanese patent application No. 2015-253699, filed on Dec. 25, 2015, the disclosure of which is incorporated herein in its entirety by reference.

### BACKGROUND

The present invention relates to a marking analysis system and marking analysis method and, for example, relates to a technique to analyze marking added to a book by a user.

When reading a book, a user mark a part of the book to which he/she pays attention by highlighting or dog-earing. When referring back to that part of the book, it is possible to easily find the part to which the user has paid attention by using this marking. The position of marking in a book is, in other words, information or a part of information which a user is interested in.

Japanese Unexamined Patent Publication No. 2012-118773 discloses an electronic book viewing system that aims at presenting, to a user, information associated with the content which the user is difficult to understand or the content which the user is interested in when viewing an electronic book. A server stores, as related information DB, micro content contained in an electronic book and each micro content in association with each other. When a user is viewing an electronic book, a user terminal calculates an estimated time required when displaying a page. The user terminal monitors a viewing time for each page and, when the viewing time exceeds the estimated time required, it determines that it is the content which the user is difficult to understand or the content which the user is interested in and presents the content of related micro content.

However, it is difficult to determine whether a user is actually interested in the content of a page based only on the viewing time of each page. For example, there is a case where a user breaks off reading to do another thing, and a long viewing time is not always due to careful reading.

On the other hand, Japanese Unexamined Patent Publication No. 2004-151899 discloses an information display processing system that aims at easily sharing the knowledge between users in an information provision system using annotation. When a user reads a document displayed in a document display area of a document viewer in a client system and adds an annotation to a word that attracts the user's interest by using an annotation device, the document viewer transmits a document ID and an annotation position to an annotation server. The annotation server stores the received document ID and annotation position into an annotation DB. An annotation processing device retrieves information that is directly related to information in a part to which an annotation has been added by another user who has added an annotation to substantially the same position as the position of the annotation added by a designated user. Then, a difference between a target character string indicated by the annotation added by the designated user and a target character string indicated by the annotation added by another user is transmitted to the document viewer as information related to a user who has the same or similar viewpoint or interest to the designated user.

### SUMMARY

However, the way of adding marking (annotation) (the frequency of marking) varies from individual to individual. For example, when the same or similar content that attracts a user's interest is written in a plurality of parts, some users mark only one of them, thus placing rather few markings, and other users mark all of them, thus placing rather many markings. Further, some users mark only a word in a part that attracts the user's interest, thus placing rather few markings, and other users mark the whole sentence in a part that attracts the user's interest, thus placing rather many markings.

Thus, because the information provision system disclosed in Japanese Unexamined Patent Publication No. 2004-151899 determines a similar user based on the degree of matching of marked positions, there is a problem that users who add markings in different ways from each other are not extracted as similar users even when a part they are interested in is the same.

The other problems and novel features of the present invention will become apparent from the description of the specification and the accompanying drawings.

### SUMMARY

According to one embodiment, a marking analysis system analyzes each of marking data indicating a plurality of positions marked by a user in a book and calculates a marking frequency for each of a plurality of unit areas in the book, and when determining that a distribution of the marking frequency of a target user and a distribution of the marking frequency of another user are similar, extracts this another user as a similar user who is similar to the target user.

According to the above embodiment, it is possible to retrieve similar users with higher accuracy.

### BRIEF DESCRIPTION OF THE DRAWINGS

The above and other aspects, advantages and features will be more apparent from the following description of certain embodiments taken in conjunction with the accompanying drawings, in which:

FIG. 1 is a view showing a schematic configuration of a marking analysis system according to a first embodiment.

FIG. 2 is a view showing a hardware configuration of a pen scanner according to the first embodiment.

FIG. 3 is a view showing a detailed configuration of the marking analysis system according to the first embodiment.

FIG. 4 is a view showing a marking data update process in the marking analysis system according to the first embodiment.

FIG. 5 is a view showing a specific example of a marking database according to the first embodiment.

FIG. 6 is a view showing a data analysis process in the marking analysis system according to the first embodiment.

FIG. 7 is a view showing a marking characteristic analysis process in the marking analysis system according to the first embodiment.

FIG. 8 is a view showing a unit area and a marking frequency according to the first embodiment.

FIG. 9 is a view showing an image of marking distribution characteristic data according to the first embodiment.

FIG. 10 is a view showing a specific example of a marking distribution characteristic database according to the first embodiment.

FIG. 11 is a view showing a similar user search process in the marking analysis system according to the first embodiment.

FIG. 12 is a view showing a reading recommendation data generation process in the marking analysis system according to the first embodiment.

FIG. 13 is a view showing a specific example of reading recommendation data according to the first embodiment.

FIG. 14 is a view showing a detailed configuration of a server according to a second embodiment.

FIG. 15 is a view showing a data analysis process in a marking analysis system according to the second embodiment.

FIG. 16 is a view showing a data analysis process in the marking analysis system according to the second embodiment.

FIG. 17 is a view showing an image of statistical information according to the second embodiment.

FIG. 18 is a view to describe calculation of the deviation of a marking frequency according to the second embodiment.

FIG. 19 is a view showing a specific example of a second marking distribution characteristic database according to the second embodiment.

FIG. 20 is a view showing a similar user search process in the marking analysis system according to the second embodiment.

FIG. 21 is a view to describe effects of the marking analysis system according to the second embodiment.

FIG. 22 is a view showing a specific example of a marking database according to a third embodiment.

FIG. 23 is a view showing a specific example of a marking distribution characteristic database according to the third embodiment.

FIG. 24 is a view showing a similar user search process in the marking analysis system according to the third embodiment.

FIG. 25 is a view to describe effects of the marking analysis system according to the third embodiment.

FIG. 26 is a view showing a hardware configuration of a pen scanner according to a fourth embodiment.

FIG. 27 is a view showing a detailed configuration of a server according to the fourth embodiment.

FIG. 28 is a view showing a specific example of a marking database according to the fourth embodiment.

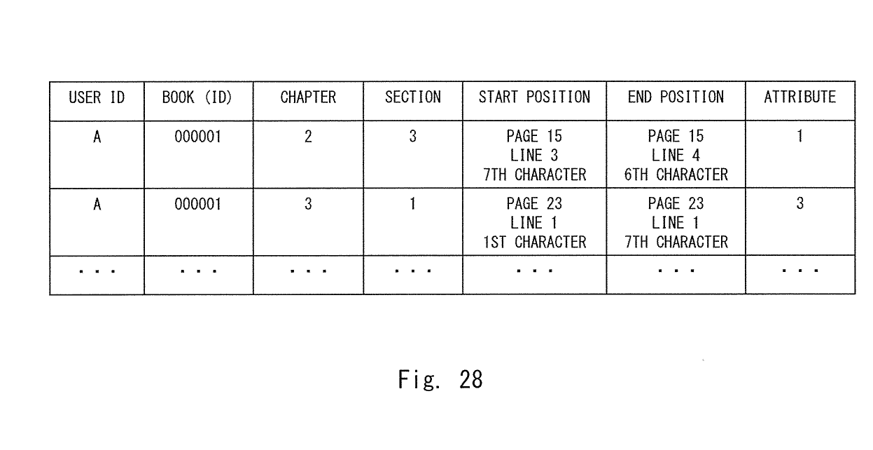

FIG. 29 is a view showing an image of marking distribution characteristic data according to the fourth embodiment.

FIG. 30 is a view showing a reading recommendation data generation process in a marking analysis system according to the fourth embodiment.

FIG. 31 is a view showing a detailed configuration of a marking analysis system according to another embodiment.

### DETAILED DESCRIPTION

Preferred embodiments of the present invention will be described hereinafter with reference to the drawings. It should be noted that specific numerical values and the like in the following embodiments are given merely for illustrative purposes, and values are not limited thereto unless particularly noted. Further, in the following description and drawings, things that are obvious to those skilled in the art and the like are appropriately omitted, shortened and simplified to clarify the explanation.

### First Embodiment

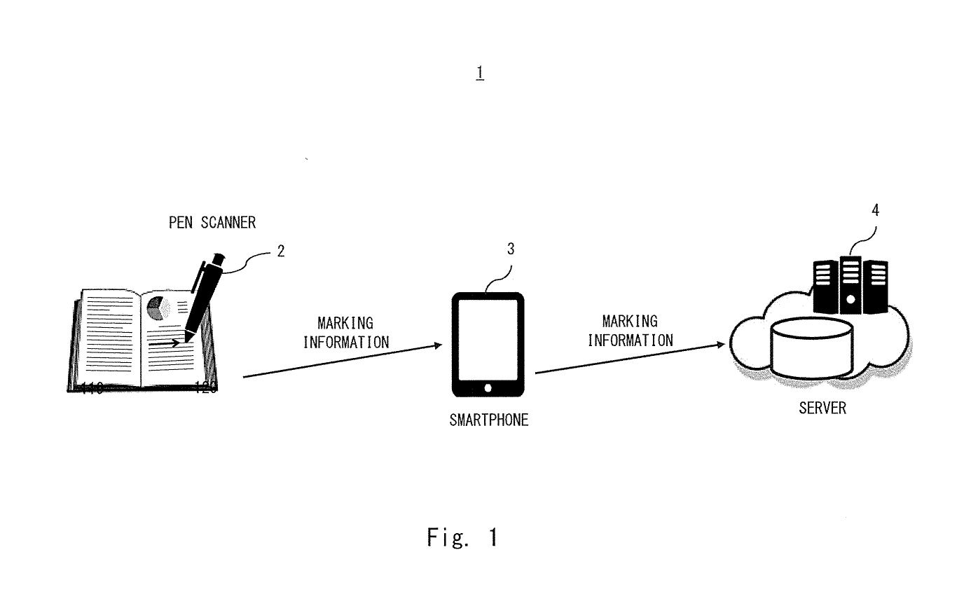

The schematic configuration of a marking analysis system 1 according to a first embodiment is described hereinafter with reference to FIG. 1. As shown in FIG. 1, the marking analysis system 1 includes a pen scanner 2, a smartphone 3, and a server 4.

The pen scanner 2 and the smartphone 3 transmit and receive arbitrary information to and from each other via arbitrary wireless communication, for example. As the wireless communication, LAN (Local Area Network) or near field radio communication such as Bluetooth can be used. Further, the smartphone 3 and the server 4 transmit and receive arbitrary information to and from each other via arbitrary wireless communication and arbitrary wired communication, for example. As the wireless communication, mobile communication (long range radio communication) such as 3GPP (Third Generation Partnership Project) or LTE (Long Term Evolution), for example, can be used. As the wired communication, Internet communication, for example, can be used.

The pen scanner 2 is a marking device that scans a paper book. When a user marks an arbitrary part of a paper book, the user performs an operation of scanning that part with the pen scanner 2. In response to the user's operation, the pen scanner 2 generates image information where the scanned part is converted into an electronic image. When a user slides the pen scanner 2 over a part of a paper book to be scanned, the pen scanner 2 continuously scans this part and generates a plurality of image information. The pen scanner 2 transmits the plurality of generated image information to the smartphone 3 as marking information that indicates the marked part of the paper book.

Although an example of using a smartphone as an information processing device that receives marking information generated by the pen scanner 2 and transfers it to the server 4 is described hereinafter in this embodiment, the type of the information processing device is not limited thereto. As the information processing device, a PC (Personal Computer), a tablet or the like may be used, for example. When the information processing device is a PC, the PC and the server 4 are configured to be able to communicate with each other via wired communication (for example, Internet communication). On the other hand, when the information processing device is a tablet, the tablet and the server 4 are configured to be able to communicate with each other via wireless communication (for example, wireless LAN) and wired communication (for example, Internet).

The server 4 is an information processing device that generates and stores information, indicating a position marked by a user in a book based on marking information received from the smartphone 3. This information is described later as “marking data”.

In the server 4, marking data corresponding to each of a plurality of users is stored. For example, the pen scanner 2 and the smartphone 3 described above are owned by the same user. Another user can also own the pen scanner 2 and the similar smartphone 3 of the same sort. Thus, the server 4 stores a plurality of marking data respectively corresponding to a plurality of users based on marking information received from each of a plurality of smartphones 3 owned by different users.

Further, the server 4 retrieves similar users to each of a plurality of users based on a plurality of marking data respectively corresponding to the plurality of users. Then, based on marking data of a user who is similar to the relevant user, the server 4 can provide the smartphone 3 of that user with information indicating a paper book to be read by the user and a part of the paper book to be read by the user.

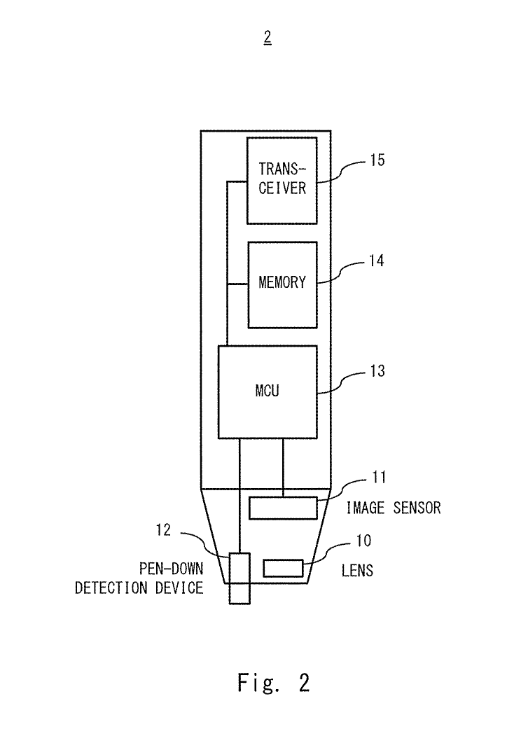

The hardware configuration of the pen scanner 2 according to the first embodiment is described hereinafter with reference to FIG. 2. As shown in FIG. 2, the pen scanner 2 includes a lens 10, an image sensor 11, a pen-down detection device 12, an MCU 13, a memory 14, and a transceiver 15.

The lens 10 forms an image of a part of a paper book that is illuminated by a light source (not shown) on the image sensor 11. The image sensor 11 photoelectrically converts the image formed by the lens and thereby generates image information. Stated differently, the image sensor 11 takes an image of (scans) a part of a paper book, generates image information presenting the part of the paper book as an electronic image, and outputs it to the MCU 13. One image presented by one image information is an image showing a selected character of a text (for example, one character or a part of one character) written in a paper book, for example.

The image sensor 11 generates the image information by performing scanning at a specified time interval.

The pen-down detection device 12 is a device that detects that the pen scanner 2 is in the pen-down state. Stated differently, the pen-down detection device 12 determines whether an imaging unit (the lens 10 and the image sensor 11) mounted on the pen point of the pen scanner 2 is in close proximity to a paper book at a predetermined distance or less. As the pen-down detection device 12, a switch or a pressure sensor, for example, may be used.

(1) When a Switch is Used as the Pen-Down Detection Device 12

When a contact surface of the switch is pressed against a paper book, and it is detected that the switch is pressed, the MCU 13 determines that the pen scanner 2 is in the pen-down state. On the other hand, when a contact surface of the switch is not pressed against a paper book, and it is detected that the switch is not pressed, the MCU 13 determines that the pen scanner 2 is in the pen-up state.

(2) When a Pressure Sensor is Used as the Pen-Down Detection Device 12

A pressure sensor detects a pressure that is applied from a paper book. When a pressure detected by the pressure sensor is equal to or more than a specified threshold, the MCU 13 determines that the pen scanner 2 is in the pen-down state. On the other hand, when a pressure detected by the pressure sensor is less than a specified threshold, the MCU 13 determines that the pen scanner 2 is in the pen-up state.

The MCU 13 is a device that controls the pen scanner 2. For example, the MCU 13 acquires the image information generated by the image sensor 11 and stores it into the memory 14. The memory 14 is a storage device in which various types of data are stored.

The transceiver 15 is a device that wirelessly transmits and receives various types of data to and from the smartphone 3. For example, the transceiver 15 converts the image information stored in the memory 14 from an electrical signal to a radio signal and transmits it to the smartphone 3.

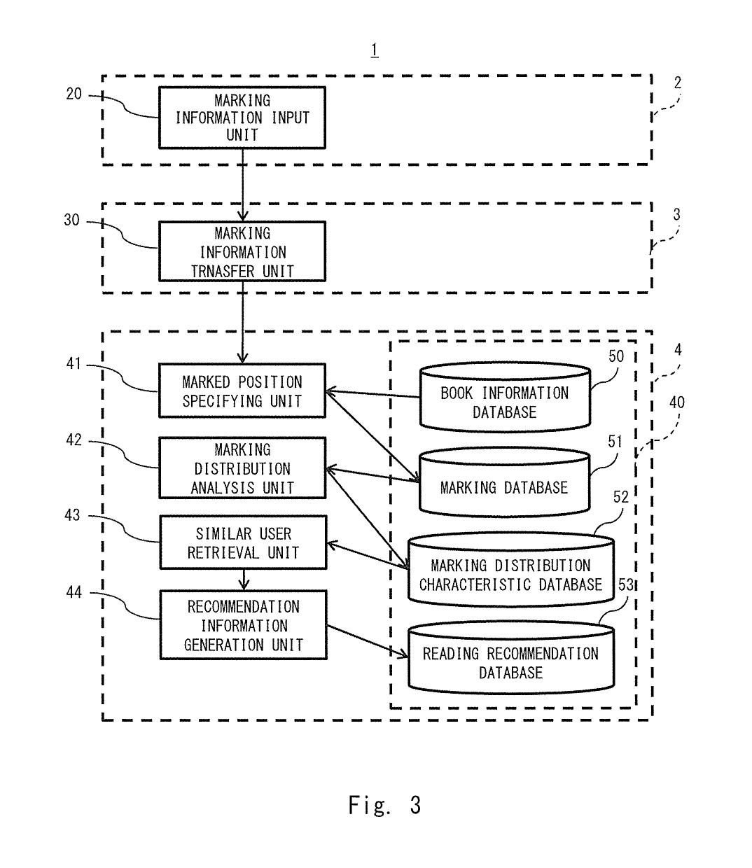

The detailed configuration of the marking analysis system 1 according to the first embodiment is described hereinafter with reference to FIG. 3.

As shown in FIG. 3, the pen scanner 2 includes a marking information input unit 20.

To the marking information input unit 20, a part which a user has scanned in a paper book with the pen scanner 2 is input as a marked part. The marking information input unit 20 generates information indicating the marked part as marking information. To be more specific, the marking information input unit 20 scans a paper book during the period when the pen scanner 2 is in the pen-down state, and thereby sequentially generates image information representing the scanned part as images and holds them. Specifically, the marking information input unit 20 generates a plurality of image information presenting a part of a paper book that has been scanned when the pen scanner 2 is in the pen-down state as a plurality of images and holds them. When the pen scanner 2 is put into the pen-up state, the marking information input unit 20 transmits the plurality of held image information, as marking information, to the smartphone 3. Specifically, the lens 10, the image sensor 11, the pen-down detection device 12, the MCU 13, the memory 14 and the transceiver 15 of the pen scanner 2 operate as the marking information input unit 20.

As shown in FIG. 3, the smartphone 3 includes a marking information transfer unit 30.

The marking information transfer unit 30 transmits the marking information received from the marking information input unit 20 to the server 4.

A CPU (Central Processing Unit) included in the smartphone 3, for example, executes a program stored in a storage means (not shown) included in the smartphone 3 and thereby operates as the above-described marking information transfer unit 30. In other words, this program contains a plurality of instructions to cause the CPU to perform the processing as the marking information transfer unit 30. Further, the storage means includes at least one of storage devices such as a volatile memory, a hard disk, and a flash memory (nonvolatile memory), for example.

As shown in FIG. 3, the server 4 includes a storage unit 40, a marked position specifying unit 41, a marking distribution analysis unit 42, a similar user retrieval unit 43, and a recommendation information generation unit 44.

The storage unit 40 stores a book information database 50, a marking database 51, a marking distribution characteristic database 52, and a reading recommendation database 53.

The book information database 50 is composed of a plurality of electronic books. Each of the electronic books is information generated by converting each of a plurality of paper books which a user possibly reads into electronic form. Hereinafter, when a paper book and an electronic book which is the electronic version of that paper book are not particularly distinguished from each other, they are also referred to simply as “book”.

The marking database 51 is composed of a plurality of marking data. Each of the plurality of marking data corresponds to a pair of each of a plurality of users and each of a plurality of books. The marking data that corresponds to a pair of a certain user and a certain book is information that indicates a plurality of positions marked by the user in the book.

The marking distribution characteristic database 52 is composed of a plurality of marking distribution characteristic data. Each of the plurality of marking distribution characteristic data corresponds to a pair of each of a plurality of users and each of a plurality of books. The marking distribution characteristic data that corresponds to a pair of a certain user and a certain book indicates the marking distribution characteristics of the book by the user. To be specific, the marking distribution characteristics are the distribution of the marking frequency at positions of a plurality of unit areas in the book.

The reading recommendation database 53 is composed of a plurality of reading recommendation data. Each of the plurality of reading recommendation data corresponds to each of a plurality of users. The reading recommendation data corresponding to a certain user shows, to the user, at least one of recommended books for reading and arbitrary parts of the recommended books for reading.

The marked position specifying unit 41 compares a character string of the marked part indicated by the marking information received from the smartphone 3 as a result of the user's marking a paper book with the pen scanner 2 with a character string of an electronic book contained in the book information database 50, and thereby specifies a marked position in the paper book. The marked position specifying unit 41 updates marking data corresponding to that user and that paper book in the marking database 51 so as to additionally show the specified marked position.

The marking distribution analysis unit 42 analyzes the plurality of marking data that constitute the marking database 51, and calculates a plurality of marking distribution characteristics respectively corresponding to a plurality of pairs of users and books. The marking distribution analysis unit 42 generates a plurality of marking distribution characteristic data indicating each of the plurality of calculated marking distribution characteristics and updates the marking distribution characteristic database 52.

The similar user retrieval unit 43 compares the distribution of the marking frequency indicated by each of the plurality of marking distribution characteristic data that constitute the marking distribution characteristic database 52 with each other, and thereby extracts, as similar users, users who are similar in the distribution of the marking frequency for each of a plurality of users.

The recommendation information generation unit 44 extracts recommended books for reading and parts of recommended books for reading for each of a plurality of users based on the plurality of marking distribution characteristic data that constitute the marking distribution characteristic database 52. The recommendation information generation unit 44 generates reading recommendation data indicating the extracted books and parts and updates the reading recommendation database 53.

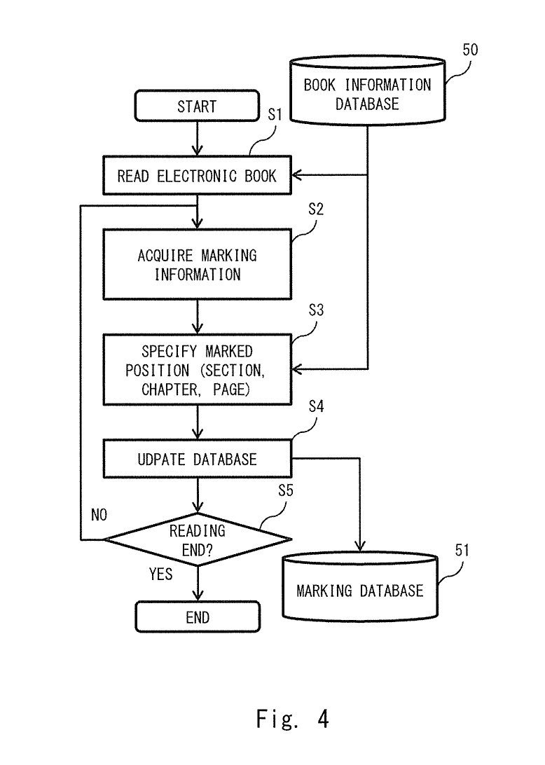

A marking data update process in the marking analysis system 1 according to the first embodiment is described hereinafter with reference to FIG. 4.

When a user starts reading a paper book, the marked position specifying unit 41 acquires, from the book information database 50, an electronic book which is the electronic version of that paper book (S1). As a method for the marked position specifying unit 41 to specify an electronic book that is the electronic version of the paper book which the user has started reading, the following method (1) or (2) may be employed, for example.

(1) A user scans a book identifier that uniquely identifies a book with the pen scanner 2.

In this method, when a user starts reading a paper book, the user scans a book identifier that uniquely identifies the paper book by using the pen scanner 2. The book identifier is a book ID, a book title or an ISBN code, for example. The pen scanner 2 thereby generates a plurality of image information obtained by scanning and transmits it as book identification information indicating the book identifier to the server 4 through the smartphone 3. Specifically, in the case of employing this method, the lens 10, the image sensor 11, the pen-down detection device 12, the MCU 13, the memory 14 and the transceiver 15 function also as a book identifier input unit (not shown).

The marked position specifying unit 41 combines a plurality of images presented by the plurality of image information received from the pen scanner 2, performs OCR (Optical Character Recognition) on the combined image and thereby acquires a character sequence of the book identifier. In other words, the marked position specifying unit 41 acquires information where the character sequence of the book identifier is presented in the form of an electronic text. Then, the marked position specifying unit 41 acquires the electronic book that is identified by the acquired book identifier from the book information database 50. For example, information that associates a book and a book identifier that uniquely identifies the book may be pre-stored in the storage unit 40, and the marked position specifying unit 41 may acquire the electronic book associated with the acquired book identifier based on the information.

Note that the above-described plurality of images are combined by superimposing a part that is the same between them on one another. Any method may be used, such as a method that extracts feature points of the respective images and specifies a part that is the same between those images based on the extracted feature points, for example. This is the same for the following description.

(2) A user enters a book identifier that uniquely identifies a book to smartphone 3.

In this method, when a user starts reading a paper book, the user enters a book identifier on an input device (not shown) of the smartphone 3. This input device is a touch panel, for example. A CPU of the smartphone 3 generates text information that contains the entered book identifier and transmits it as book identification information to the server 4. Specifically, in the case of employing this method, a CPU of the smartphone 3 functions also as a book identifier input unit (not shown) in collaboration with the input device.

The marked position specifying unit 41 acquires, from the book information database 50, the electronic book that is associated with the book identifier indicated by the text information received from the smartphone 3. For example, the same information as described in the above method (1) may be pre-stored in the storage unit 40, and the electronic book may be acquired by the same way as described above.

Each time a user marks a paper book with the pen scanner 2, the marked position specifying unit 41 receives the marking information that is transmitted form the pen scanner 2 through the smartphone 3 (S2).

The marked position specifying unit 41 combines a plurality of images presented by the plurality of image information received as the marking information from the pen scanner 2, performs OCR on the combined image, and thereby acquires a character sequence of the marked part. Specifically, the marked position specifying unit 41 acquires information where the character sequence of the marked part is presented in the form of an electronic text. Then, the marked position specifying unit 41 compares the acquired character sequence of the marked part with the text of the electronic book acquired in the step S1, and thereby specifies a marked position of the character sequence of the marked part in the book (S3).

For example, the electronic book may be information that contains a character string generated by converting a text in a paper book into an electronic text, and the marked position may be specified by comparing the character string of the electronic text and the character string of the acquired marked part. Further, the electronic book may be information that contains an image generated by converting a paper book into electronic form, the character string of a document in the electronic book may be converted into a text by performing OCR on the image, and the marked position may be specified by comparing the character string of the electronic text and the character string of the acquired marked part.

In this step, the marked position specifying unit 41 acquires, as the marked position, a section, a chapter, a page, a line and the like where the character string in the marked part is located in the book. For example, information that associates each character in a book and the position (section, chapter, page, line etc.) of each character may be pre-stored in the storage unit 40, so that the marked position specifying unit 41 can specify the start position and the end position of a character string that matches the character string of the marked part in the book. Further, this information may be contained in the electronic book.

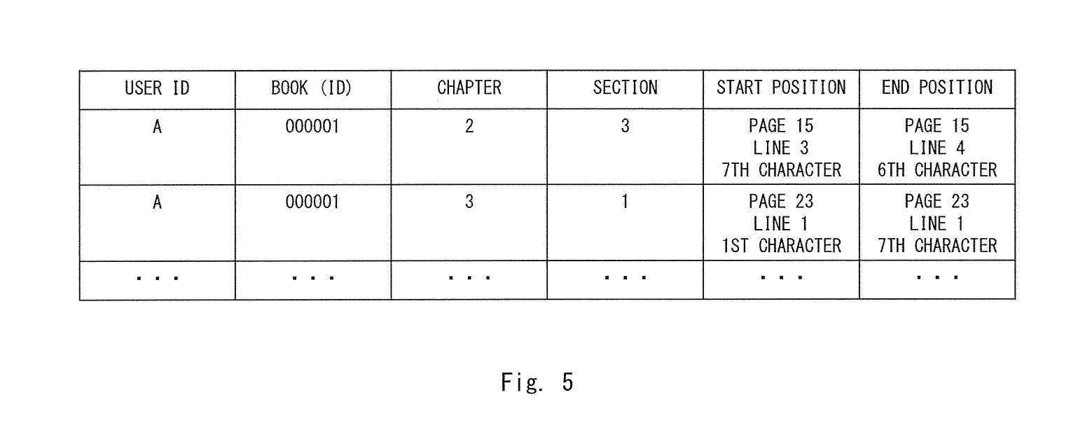

The marked position specifying unit 41 updates the marking data in the marking database 51 so as to additionally indicate the acquired marked position (S4). Specifically, the updated marking data is marking data that corresponds to a pair of a paper book and a user who has marked the paper book. A specific example of the marking database 51 is described hereinafter with reference to FIG. 5.

As shown in FIG. 5, the marking database 51 contains a plurality of information indicating a user identifier that uniquely identifies a user, a book identifier that uniquely identifies a book, a chapter number where a character string marked by a user in the book is located, a section number where the marked character string is located, a start position (page number, line number and character number) of the marked character string, and an end position (page number, line number and character number) of the marked character string. Specifically, marking data that corresponds to a pair of a certain user and a certain book, out of a plurality of marking data that constitute the marking database 51, contains the same number of information indicating a user identifier of the user and a book identifier of the book as the number of parts marked by the user in the book.

“Page number” indicates in which page a character at the start or end position is located, “line number” indicates in which line a character at the start or end position is located in that page, and “character number” indicates in which place a character at the start or end position is located in that line.

A user identifier is an identifier that uniquely identifies a user. The user identifier is a user ID or a user name, for example. Note that FIG. 5 shows an example of using a user ID as the user identifier. As a method for the marked position specifying unit 41 to recognize a user identifier, the following method (1) or (2) may be employed, for example.

(1) Transmit, to the server 4, a user identifier pre-stored in the pen scanner 2 or the smartphone 3

In this method, user identification information indicating a user identifier is stored in advance in a nonvolatile storage device (not shown) included in the pen scanner 2, for example, and thereby the pen scanner 2 acquires the user identification information from the nonvolatile storage device at specified timing, and transmits it to the server 4 through the smartphone 3. Further, for example, user identification information is stored in advance in a nonvolatile storage device included in the smartphone 3, and thereby the smartphone 3 acquires the user identification information from the nonvolatile storage device at arbitrary timing, and transmits it to the server 4. Then, the marked position specifying unit 41 recognizes the user identifier indicated by the received user identification information as a user identifier of a user who has marked a book.

(2) Transmit, to the server 4, a user identifier entered by a user to the smartphone 3

In this method, a user enters a user identifier with an input device of the smartphone 3 at specified timing. The smartphone 3 generates text information indicating the entered user identifier in the form of an electronic text and transmits it as user identification information to the server 4. Then, the marked position specifying unit 41 recognizes the user identifier indicated by the received user identification information as a user identifier of a user who has marked a book.

Note that the above-described specified timing may be timing when communication with the server 4 is connected after the completion of activation of the pen scanner 2 or the smartphone 3 or arbitrary timing like the timing of the step S1.

The marked position specifying unit 41 updates the marking data in the marking database 51 so as to add information indicating the user identifier recognized as above, the book identifier acquired in the step S1, and the section number, the chapter number, the start position (page number, line number and character number) and the end position (page number, line number and character number) specified in the step S3.

The marked position specifying unit 41 determines whether the user has finished reading (S5). As a method for the marked position specifying unit 41 to determine whether the user has finished reading or not, the following method (1) or (2) may be employed, for example.

(1) A user enters the end of reading to the pen scanner 2.

In this method, when a user finishes reading a paper book, the user enters the end of reading with an input device of the pen scanner 2. For example, this input device may be a physical operation button on the pen scanner 2, and the pressing of the operation button may be treated as the entering of the end of reading. In response to the entering of the end of reading, a CPU of the pen scanner 2 generates notification information that notifies the end of reading and transmits it to the server 4 through the smartphone 3.

The marked position specifying unit 41 of the server 4 determines that the user has not finished reading during the period when it does not receive notification information from the pen scanner 2. On the other hand, when the marked position specifying unit 41 receives notification information from the pen scanner 2, it determines that the user has finished reading.

(2) A user enters the end of reading to the smartphone 3.

In this method, when a user finishes reading a paper book, the user enters the end of reading with an input device of the smartphone 3. For example, this input device may be a touch panel on the smartphone 3, and the pressing of a virtual operation button displayed on the touch panel may be treated as the entering of the end of reading. In response to the entering of the end of reading, a CPU of the smartphone 3 generates notification information that notifies the end of reading and transmits it to the server 4.

The marked position specifying unit 41 of the server 4 determines that the user has not finished reading during the period when it does not receive notification information from the smartphone 3. On the other hand, when the marked position specifying unit 41 receives notification information from the smartphone 3, it determines that the user has finished reading.

In the case where the marked position specifying unit 41 determines that the user has not finished reading (No in S5), it performs processing from the step S2 again in response to receiving new marking information. On the other hand, the marked position specifying unit 41 determines that the user has finished reading (Yes in S5), it ends the marking data update process.

The server 4 may continue the processing steps S2 to S4 without determining whether the user has finished reading or not. In this case, the marked position specifying unit 41 may return to the step S1 in response to receiving new book identification information.

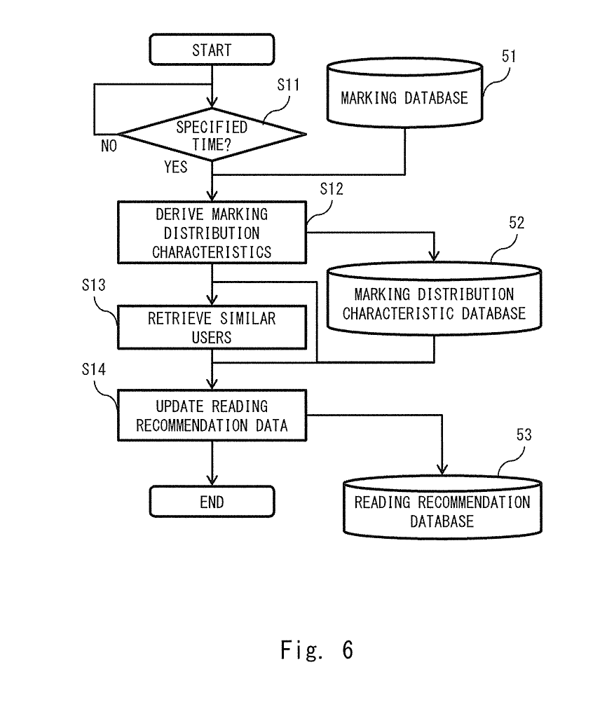

A data analysis process in the marking analysis system 1 according to the first embodiment is described hereinafter with reference to FIG. 6.

When the specified time is reached (S11), the marking distribution analysis unit 42 analyzes a plurality of marking data that constitute the marking database 51 and thereby derives a plurality of marking distribution characteristics, each corresponding to a pair of each of all users and each of all books (S12). The marking distribution analysis unit 42 generates a plurality of marking distribution characteristic data respectively indicating the plurality of derived marking distribution characteristics, and updates the marking distribution characteristic database 52. Thus, all of the marking distribution characteristic data, each corresponding to a pair of each of all users and each of all books, are updated.

The similar user retrieval unit 43 compares a plurality of marking distribution characteristics indicated by a plurality of marking distribution characteristic data that constitute the marking distribution characteristic database 52 with each other, and thereby retrieves similar users who are similar in the marking distribution characteristics to each of all users (S13). The similar user retrieval unit 43 compares the marking distribution characteristics of a target user, which is each of all users selected in turn, with each of the marking distribution characteristics of users other than the target user. When the marking distribution characteristics of the target user and the marking distribution characteristics of another user are similar, the similar user retrieval unit 43 extracts this user as a similar user who is similar to the target user.

The recommendation information generation unit 44 compares the positions of a plurality of marked parts between a user and a similar user for each of all users based on a plurality of marking distribution characteristic data that constitute the marking distribution characteristic database 52, and it derives recommended paper books for reading and recommended parts for reading which correspond to each of all users. The recommendation information generation unit 44 generates a plurality of reading recommendation data indicating each of a plurality of pairs of derived paper books and parts, and updates the reading recommendation database 53 (S14). Thus, all of the reading recommendation data corresponding to each of all users is updated.

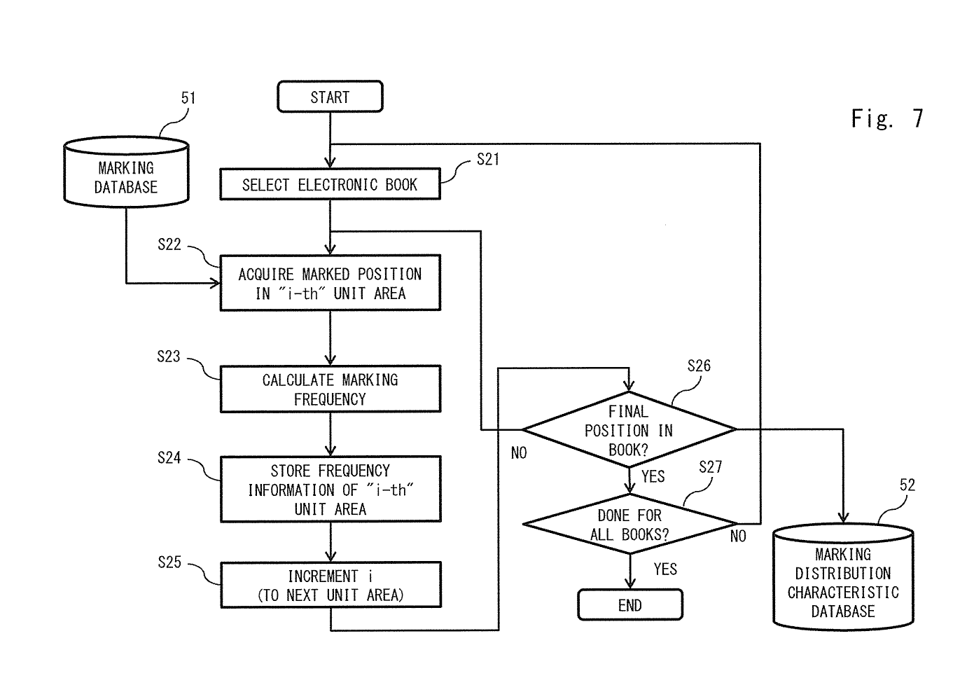

A marking characteristics analysis process (S12) in the marking analysis system 1 according to the first embodiment is described hereinafter with reference to FIG. 7. Note that this process is performed for each of all users. Specifically, this process is performed by selecting all users in turn. Hereinafter, a user selected as a target to analyze the marking distribution characteristics is referred to also as “target user”.

The marking distribution analysis unit 42 selects and acquires one electronic book from the book information database 50 (S21). The marking distribution analysis unit 42 acquires the marked position in the “i-th” unit area from a plurality of marked positions indicated by the marking data in the marking database 51 which corresponds to the target user and the book selected in the step S21 (S22). Note that “i” starts with 1. The marking distribution analysis unit 42 calculates a marking frequency in the unit area based on the acquired marked position (S23).

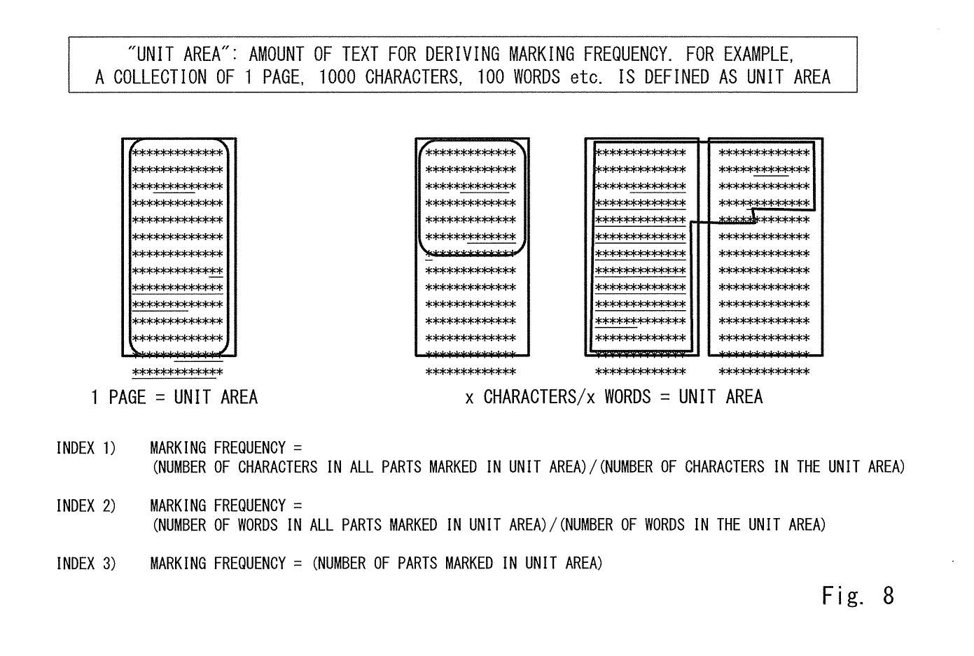

“Unit area” and “marking frequency” are described hereinafter with reference to FIG. 8. “Unit area” is a specified amount of text for deriving a marking frequency in a book. A unit area is defined as each area separated by every page, every specified number of characters (for example, 1000 characters) or every specified number of words (for example, 100 words) as shown in FIG. 8, for example.

The marking frequency uses any of the following indices 1 to 3, for example.

Marking frequency=(the number of characters in all parts marked in a unit area)/(the number of characters in the unit area) Index 1)

Marking frequency=(the number of words in all parts marked in a unit area)/(the number of words in the unit area) Index 2)

Marking frequency=(the number of parts marked in a unit area) Index 3)

The marking distribution analysis unit 42 stores, into the storage unit 40, the calculated marking frequency in association with the “i-th” unit area (S24). The marking distribution analysis unit 42 increments the value of “i” (S25). In other words, the marking distribution analysis unit 42 sets the next area as a processing target.

The marking distribution analysis unit 42 determines whether the final position of the book is reached or not (S26). Specifically, when a unit area before increment is the final unit area, the marking distribution analysis unit 42 determines that the final position of the book is reached and, otherwise, determines that the final position of the book is not reached. In other words, when “i” reaches “the number of unit areas +1” in the book selected in the step S21, it is determined that the final position of the book is reached.

When it is determined that the final position of the book is not reached (No in S26), the marking distribution analysis unit 42 performs the process from the step S22 for the next unit area. On the other hand, when it is determined that the final position of the book is reached (Yes in S26), the marking distribution analysis unit 42 generates, as marking distribution characteristic data, information indicating each of the marking frequencies stored in the storage unit 40 in association with each of all unit areas in the book, and updates the marking distribution characteristic database 52. Specifically, the marking distribution characteristic data corresponding to a pair of the target user and the book selected in the step S21 is updated in the marking distribution characteristic database 52.

The marking distribution analysis unit 42 determines whether the marking distribution characteristic data has been generated for all books (S27). When the generation of the marking distribution characteristic data is not done for all books (No in S27), the marking distribution analysis unit 42 performs the process from the step S21 again. Note that, at this time, the marking distribution analysis unit 42 selects and acquires one book that is not yet selected from the book information database 50 (S21). When the generation of the marking distribution characteristic data is done for all books (Yes in S27), the process of marking characteristics analysis (S12) ends.

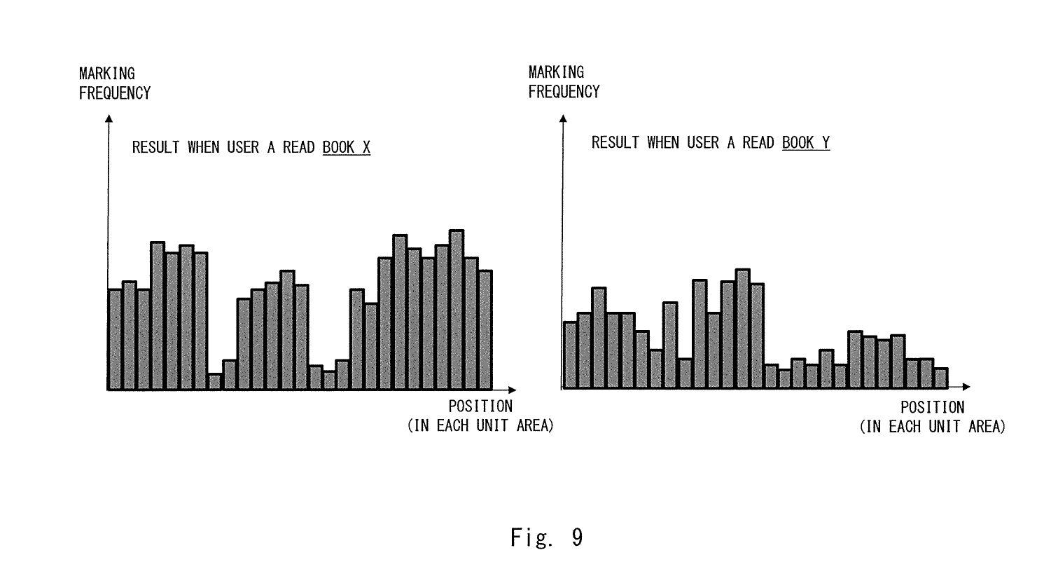

The marking distribution characteristic data is described hereinafter with reference to FIG. 9. As shown in FIG. 9, the marking distribution characteristic data indicates the quantification of the frequency of marking added to a book by a user in each unit area as the distribution of the marking frequency. The marking frequency is high at a part to which a user pays attention in a book, and the marking frequency is low at a part to which the user does not pay attention in the book.

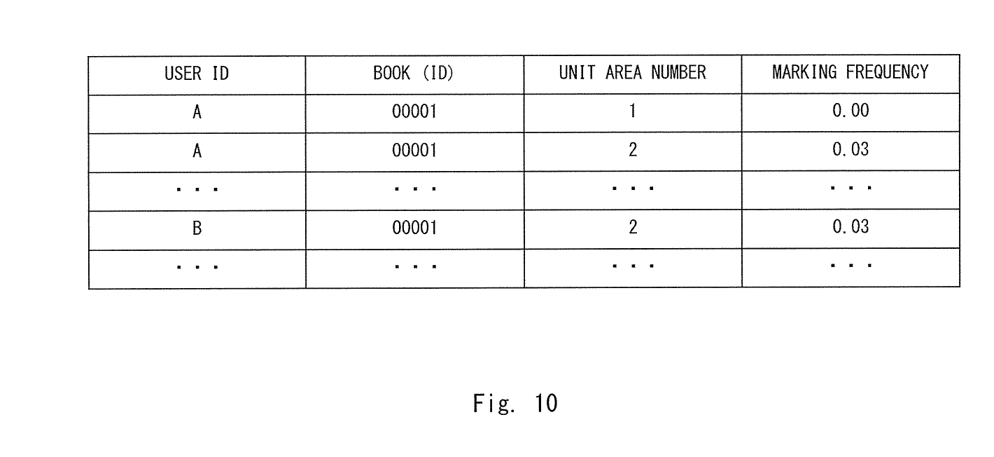

A specific example of the marking distribution characteristic database 52 is described hereinafter with reference to FIG. 10. As shown in FIG. 10, the marking distribution characteristic database 52 contains a plurality of information indicating a user identifier, a book identifier, a unit area number in the book identified by the book identifier, and a marking frequency in the unit area indicated by the unit area number by the user identified by the user identifier. Note that FIG. 10 shows an example where a user ID is used as the user identifier and a book ID is used as the book identifier. Specifically, the marking distribution characteristic data corresponding to a pair of a certain user and a certain book, out of a plurality of marking distribution characteristic data that constitute the marking distribution characteristic database 52, contains the same number of information indicating the user identifier of that user and the book identifier of that book as the number of unit areas in the book.

The user identifier and the book identifier are as described above. The unit area number is a number that uniquely identifies a unit area. The unit area numbers, which start with “1”, are generally assigned sequentially from the beginning of a book, and the unit area number corresponds to “i” in the above-described “i-th” unit area. The marking frequency is also as described above. Note that, for a unit area with no marking, the marking frequency may be set to “0” as a specified default value as shown in FIG. 10, for example.

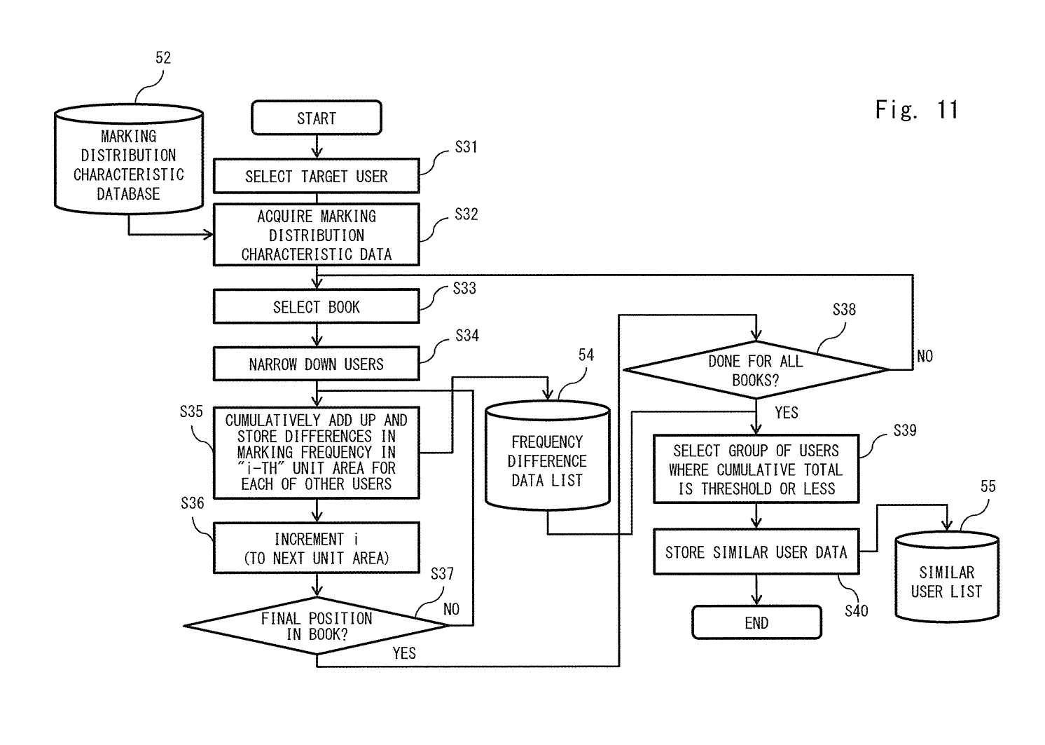

A similar user search process (S13) in the marking analysis system 1 according to the first embodiment is described hereinafter with reference to FIG. 11. Note that this process is performed for each of all users. Specifically, this process is performed by selecting all users in turn. Hereinafter, a user selected as a target to analyze similar users is referred to also as “target user”.

The similar user retrieval unit 43 selects a target user (S31). The similar user retrieval unit 43 acquires a plurality of marking distribution characteristic data corresponding to the target user from the marking distribution characteristic database 52 (S32). The similar user retrieval unit 43 selects one book from a plurality of books read by the target user (S33). As this book, any one of different book identifiers extracted from a plurality of book identifiers indicated by a plurality of marking data corresponding to the target user may be selected, for example.

The similar user retrieval unit 43 specifies other users who have placed marking in the same book as the book selected in the step S33 (S34). As other users, a user of the user identifier indicated by the marking data indicating the book identifier of the book selected in the step S33, out of a plurality of marking data respectively corresponding to a plurality of users other than the target user, may be selected, for example.

The similar user retrieval unit 43 calculates, for the book selected in the step S33, a difference between the marking frequency in the “i-th” unit area of the target user and the marking frequency in the “i-th” unit area of each of the other users specified in the step S34, and calculates the cumulative total of the calculated differences for each of the other users specified in the step S34.

Specifically, when i=1, the similar user retrieval unit 43 uses the calculated difference as the cumulative total. When the similar user retrieval unit 43 calculates a value obtained by adding the calculated difference to the cumulative total as a new cumulative total. The similar user retrieval unit 43 updates the cumulative total for each pair of the target user and each of the other users specified in the step S34 to the calculated cumulative total in a frequency difference data list 54 (S35). Note that “i” starts with “1”.

The frequency difference data list 54 is composed of a plurality of cumulative totals. Each of the plurality of cumulative totals corresponds to each of possible pairs of two different users. Specifically, the cumulative total that corresponds to a pair of certain two users indicates the cumulative total of differences in the marking frequency between the unit areas indicated by the marking distribution characteristic data of those two users. The frequency difference data list 54 is stored in the storage unit 40 of the server 4.

The similar user retrieval unit 43 increments i (S36). Stated differently, the marking distribution analysis unit 42 sets the next unit area as a processing target. The similar user retrieval unit 43 determines whether the final position of the book is reached or not (S37). A method for this determination is the same as the one described above in the step S26.

When it is determined that the final position of the book is not reached (No in S37), the similar user retrieval unit 43 performs the process from the step S35 for the next unit area. On the other hand, when it is determined that the final position of the book is reached (Yes in S37), the similar user retrieval unit 43 determines whether the calculation of the cumulative total is done for all books read by the target user (S38).

When the calculation of the cumulative total is not done for all books read by the target user (No in S38), the similar user retrieval unit 43 performs the process from the step S33 again. Note that, at this time, the similar user retrieval unit 43 selects one book that is not yet selected from all books read by the target user (S33). When the calculation of the cumulative total is done for all books read by the target user (Yes in S38), the similar user retrieval unit 43 selects, from the users specified in the step S34, users whose cumulative total with the target user is equal to or less than a specified threshold (S39). The similar user retrieval unit 43 generates similar user data that indicates the selected users as similar users and updates a similar user list 55 (S40).

The similar user list 55 is composed of a plurality of similar user data. Each of the plurality of similar user data corresponds to each of different users. The similar user data is information indicating similar users who are similar to a certain user. The similar user list 55 is stored in the storage unit 40 of the server 4. Thus, in the step S40, the similar user data corresponding to the target user is updated in the similar user list 55.

Note that, although it is determined, in the above description, that the target user and another user are similar when the cumulative total of differences in the marking frequency of the unit area between the target user and another user is equal to or less than a threshold for all books read by a target user, it is not limited thereto. For example, it may be determined that the target user and another user are similar when the mean of differences in the marking frequency of the unit area between of the target user and another user is equal to or less than a threshold for all books read by a target user. In this case also, for each of all books read by the target user and another user, the distribution of the marking frequency indicated by the marking distribution frequency data of the target user and the distribution of the marking frequency indicated by the marking distribution frequency data of another user are similar as a whole, and it is considered that books and parts in which the target user and another user are interested are similar.

For example, the cumulative total of differences in the marking frequency may be calculated for each book, not for all books read by the target user, and when the cumulative total of differences in the marking frequency of the unit area between the target user and another user is equal to or less than a threshold for at least any one of them, it may be determined that the target user and another user are similar. Further, for example, the mean of differences in the marking frequency may be calculated for each book, and when the mean of differences in the marking frequency of the unit area between the target user and another user is equal to or less than a threshold for at least any one of them, it may be determined that the target user and another user are similar. In those cases also, for a book read by the target user and another user, the distribution of the marking frequency indicated by the marking distribution frequency data of the target user and the distribution of the marking frequency indicated by the marking distribution frequency data of another user are similar, and it is considered that books and parts in which the target user and another user are interested are similar.

As described above, in the first embodiment, users who have an interest in similar books and parts to a certain user are determined by comparing the distribution of the marking frequency with respect to a position of a unit area in a book. Thus, even when the way of adding marking varies by users, it is possible to retrieve similar users with high accuracy. Because the determination of a similarity between users is made based on the marking distribution characteristics, which is the distribution of the marking frequency, it is possible to detect that a part they are interested in is the same even when the marked positions do not completely coincide.

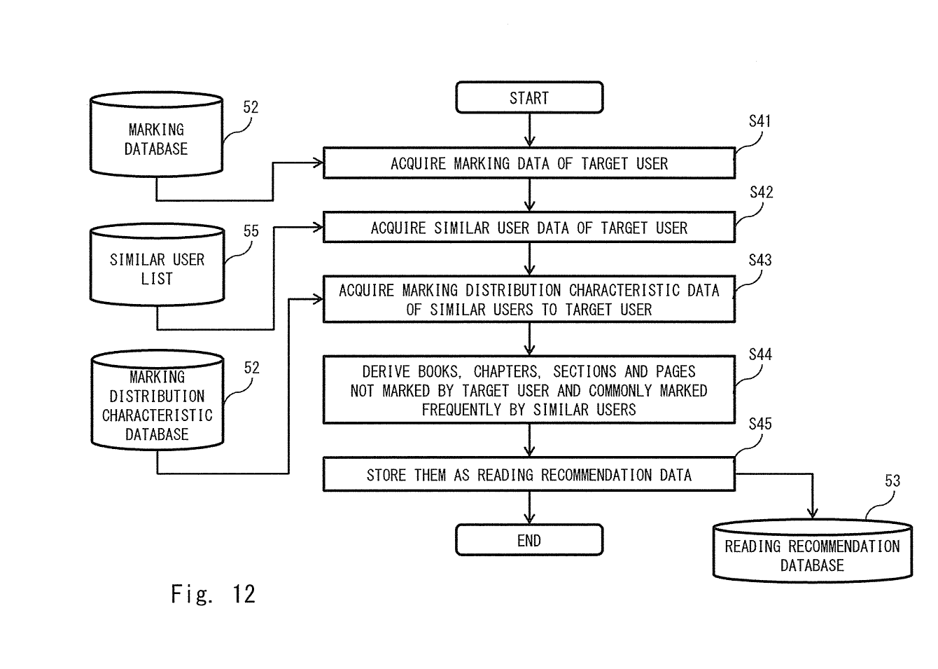

A reading recommendation data generation process (S14) in the marking analysis system 1 according to the first embodiment is described hereinafter with reference to FIG. 12. Note that this process is performed for each of all users. Specifically, this process is performed by selecting all users in turn. Hereinafter, a user selected as a target to analyze similar users is referred to also as “target user”.

The recommendation information generation unit 44 acquires a plurality of marking data corresponding to the target user from the marking database 51 (S41). The recommendation information generation unit 44 acquires similar user data corresponding to the target user from the similar user list 55 (S42). The recommendation information generation unit 44 acquires a plurality of marking distribution characteristic data corresponding to the similar users indicated by the similar user data acquired in the step S42 from the marking distribution characteristic database 52 (S43).

Based on the plurality of acquired marking data of the target user and the plurality of acquired marking distribution characteristic data of the similar users, the recommendation information generation unit 44 derives books, chapters, sections and pages to which marking is not added by the target user and in which the marking frequency is commonly high among the similar users (S44).

In this step, the recommendation information generation unit 44 calculates the marking frequency for each book, each chapter, each section and each page based on the marking distribution characteristic data of the similar users acquired in the step S43. To be specific, the recommendation information generation unit 44 calculates, as the marking frequency for each book, the sum or the mean of the marking frequencies in all unit areas contained in the book, for each of the similar users. The recommendation information generation unit 44 calculates, as the marking frequency for each chapter, the sum or the mean of the marking frequencies in all unit areas contained in the chapter, for each of the similar users. The recommendation information generation unit 44 calculates, as the marking frequency for each section, the sum or the mean of the marking frequencies in all unit areas contained in the section, for each of the similar users. The recommendation information generation unit 44 calculates, as the marking frequency for each page, the sum or the mean of the marking frequencies in all unit areas contained in the page, for each of the similar users.

Note that, when chapter, section and page breaks and unit area breaks do not coincide, the recommendation information generation unit 44 may calculate the marking frequency in each of chapters, sections and pages based on the marking data of the similar users.

Then, the recommendation information generation unit 44 derives top ten books, top ten chapters, top ten sections and top ten pages, each in descending order of the marking frequency.

At this time, based on the plurality of marking data acquired in the step S41, the recommendation information generation unit 44 excludes books chapters, sections and pages which the target user has already read from the books, chapters, sections and pages derived in this step. Specifically, the books chapters, sections and pages which contain the marked positions indicated by the plurality of marking data acquired in the step S41 are excluded from the books, chapters, sections and pages derived at this time.

The recommendation information generation unit 44 generates reading recommendation data that indicates the derived books, chapters, sections and pages with high marking frequencies and updates the reading recommendation database 53 (S45).

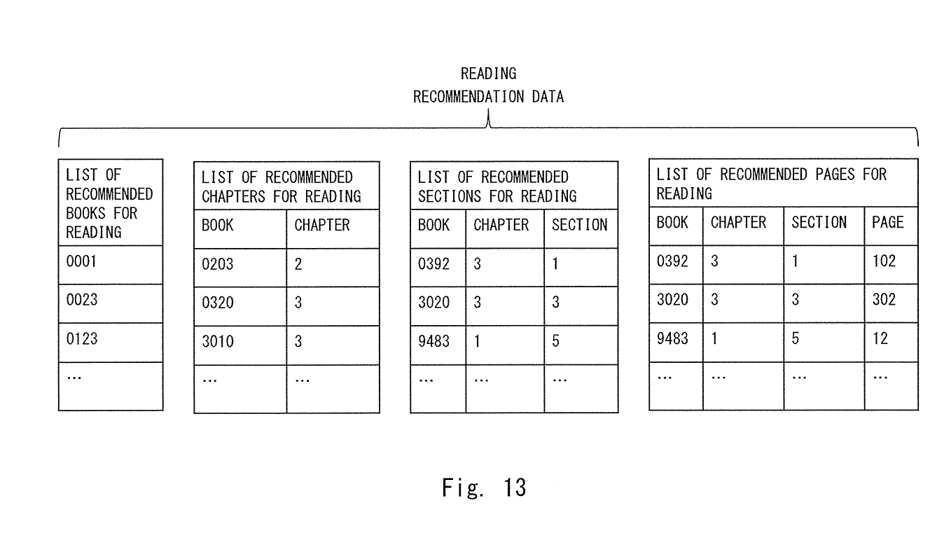

A specific example of reading recommendation data is described hereinafter with reference to FIG. 13. As shown in FIG. 13, the reading recommendation data contains a list of recommended books for reading, a list of recommended chapters for reading, a list of recommended sections for reading, and a list of recommended pages for reading.

The list of recommended books for reading is information that indicates top ten books in descending order of the marking frequency. The list of recommended books for reading indicates, by a book identifier, each of the top ten books in descending order of the marking frequency. Note that FIG. 13 shows an example of using a book ID as the book identifier.

The list of recommended chapters for reading is information that indicates top ten chapters in descending order of the marking frequency. The list of recommended chapters for reading indicates each of the top ten chapters in descending order of the marking frequency, by a book identifier of a book containing the chapter and a chapter number of the chapter.

The list of recommended sections for reading is information that indicates top ten sections in descending order of the marking frequency. The list of recommended sections for reading indicates each of the top ten sections in descending order of the marking frequency, by a book identifier of a book containing the section, a chapter number containing the section, and a section number of the section.

The list of recommended pages for reading is information that indicates top ten pages in descending order of the marking frequency. The list of recommended pages for reading indicates each of the top ten pages in descending order of the marking frequency, by a book identifier of a book containing the page, a chapter number containing the page, a section number containing the page, and a page number of the page.

A user can thereby find books and parts (chapters, sections and pages) which the user should read by referring to the reading recommendation data. To be specific, when a user refers to the reading recommendation data of his/herself, the user enters a request for display of the reading recommendation data to the input device of the smartphone 3. In response to the entering, a CPU of the smartphone 3 transmits request information that requests the reading recommendation data to the server 4. This request information indicates a user identifier of the user of the smartphone 3.

In response to receiving the request information from the smartphone 3, a CPU of the server 4 acquires the reading recommendation data of the user corresponding to the user identifier indicated by the request information from the reading recommendation database 53 and transmits it to the smartphone 3.

In response to receiving the reading recommendation data from the server 4, the CPU of the smartphone 3 displays each list indicated by the received reading recommendation data on a display device of the smartphone 3. The display device is a touch panel, for example.

In this configuration, a user can refer to books and parts of books which users who are similar to him/herself have read even if the user has not read those books. Therefore, a user can effectively find books or parts of books which he/she should read by using, as reference, books and parts of books that have been read by users who have an interest in similar books and parts to him/herself.

Note that, although an example of extracting top ten books and parts in descending order of the marking frequency as those indicated by the reading recommendation data is described above, it is not limited thereto. Specifically, a top specified number of books and parts (books and parts from the first to an arbitrary place in rank in descending order of the marking frequency) may be extracted. Further, the number of books, chapters, sections and pages to be extracted may be different among them.

Further, although an example of extracting books, chapters, sections and pages as those indicated by the reading recommendation data is described above, it is not limited thereto. At least one of books, chapters, sections and pages may be extracted.

As described above, in the first embodiment, the storage unit 40 stores, as the marking database 51 (which corresponds to a marking data storage unit), a plurality of marking data indicating a plurality of positions marked by a user in a book, which respectively correspond to a plurality of users. The marking distribution analysis unit 42 analyzes the marking data in the marking database 51 stored in the storage unit 40 and thereby calculates the marking frequency for each of a plurality of unit areas in the book, and generates the marking distribution characteristic data indicating the distribution of the marking frequency with respect to a position in the unit area. The storage unit 40 stores, as the marking distribution characteristic database 52 (which corresponds to a marking distribution characteristic data storage unit), the marking distribution characteristic data generated by the marking distribution analysis unit 42. Then, when the similar user retrieval unit 43 determines that the distribution of the marking frequency indicated by the marking distribution characteristic data of the target user selected as a processing target and the distribution of the marking frequency indicated by the marking distribution characteristic data of another user are similar, it extracts this another user as a similar user who is similar to the target user.

In this configuration, because the determination of a similarity between users is made based on the marking distribution characteristics, which is the distribution of the marking frequency, it is possible to detect that parts they are interested in are the same even when the marked positions do not completely coincide. Thus, even when the way of adding marking varies by users, it is possible to retrieve similar users with high accuracy.

Further, as described above, in the first embodiment, based on the marking distribution characteristic data generated for books which a target user selected as a processing target has not added any marking, out of a plurality of marking distribution characteristic data of similar users who are similar to the target user, the recommendation information generation unit 44 generates, as the reading recommendation data for the target user, data indicating at least one of books to which the target user has not added any marking and to which similar users have added marking and marked parts in books to which the target user has not added any marking and to which similar users have added marking.

In this configuration, a user can find books or parts of books which he/she should read by using, as reference, books or parts of books that have been read by users who have an interest in similar books and parts to him/herself

Further, the recommendation information generation unit 44 generates, as the reading recommendation data, data indicating at least one of a top specified number of books in descending order of the marking frequency of each of a plurality of similar users who are similar to the target user and a top specified number of parts of books in descending order of the marking frequency of each of the plurality of similar users.

In this configuration, because a user can refer only to books or parts which similar users are highly interested in, it is possible to find books or parts in which the user is likely to have a high interest.

Further, as described above, the marking analysis system 1 according to the first embodiment includes the pen scanner 2 having the marking information input unit 20 to input information about marking in a book by a user, and the server 4 having the marked position specifying unit 41, the marking distribution analysis unit 42 and the similar user retrieval unit 43. The storage unit 40 stores, as the book information database 50 (which corresponds to an electronic book storage unit), electronic books that are the electronic versions of paper books. The pen scanner 2 receives an operation of scanning a paper book as an input to mark a paper book, generates image information presenting an image of a character string scanned on the paper book, and transmits it to the server. Then, the marked position specifying unit 41 checks the character string shown in the image information received from the pen scanner 2 against a character string shown in the electronic book, and thereby specifies a marked position.

In this configuration, even when a marked book is a paper book, not an electronic book, it is possible to retrieve similar users who are similar to a user who has marked the book. Further, it is possible to present books or parts which the user should read based on marked positions of the similar users.

### Second Embodiment

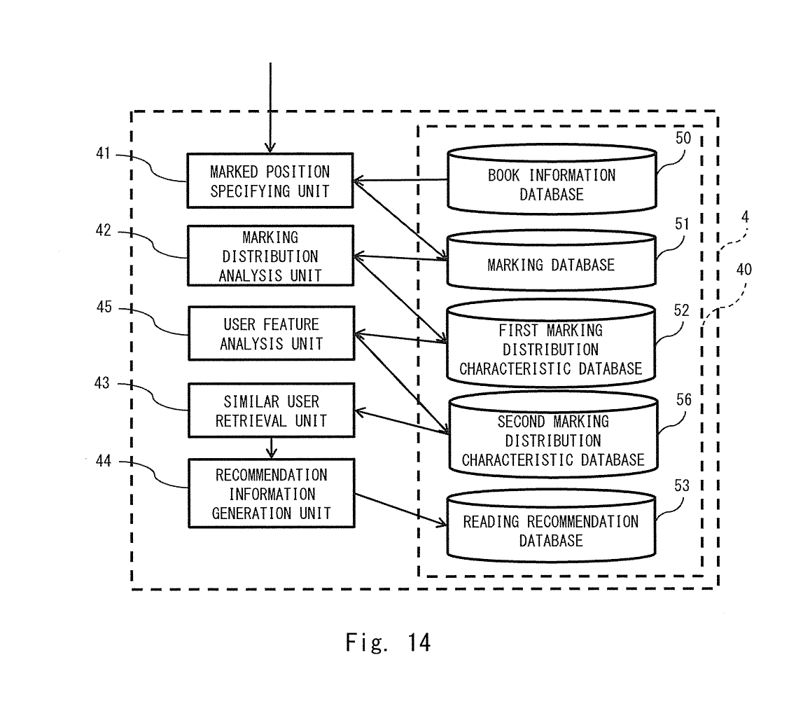

A second embodiment is described hereinafter. In the following description, the same matter as in the first embodiment described above is denoted by the same reference symbol or the like, and the description thereof is omitted as appropriate. The schematic configuration of the scanning system 1, the hardware configuration of the pen scanner 2, and the detailed configurations of the pen scanner 2 and the smartphone 3 according to the second embodiment are the same as those according to the first embodiment and thus not redundantly described. First, the detailed configuration of the server 4 according to the second embodiment is described hereinafter with reference to FIG. 14.

As shown in FIG. 14, the server 4 according to the second embodiment is different from the server 4 according to the first embodiment in that it further includes a user feature analysis unit 45. Further, the storage unit 40 according to the second embodiment is different from the storage unit 40 according to the first embodiment in that it further stores a second marking distribution characteristic database 56. A first marking distribution characteristic database 52 that is stored in the storage unit 40 according to the second embodiment corresponds to the marking distribution characteristic database 52 that is stored in the storage unit 40 according to the first embodiment. Hereinafter, marking distribution characteristic data in the first marking distribution characteristic database 52 is referred to also as “first marking distribution characteristic data”.

The second marking distribution characteristic database 56 is composed of a plurality of second marking distribution characteristic data. The plurality of second marking distribution characteristic data are information where the plurality of first marking distribution characteristic data that constitute the first marking distribution characteristic database 52 are converted into different forms. In other words, each of the plurality of second marking distribution characteristic data corresponds to a pair of each of a plurality of users and each of a plurality of books.

The user feature analysis unit 45 analyzes a plurality of marking distribution characteristics indicated by the plurality of first marking distribution characteristic data for each of all users, and thereby derives marking features (the way of marking) of that user. Based on the derived marking features, the user feature analysis unit 45 converts each of the plurality of first marking distribution characteristic data corresponding to that user into the second marking distribution characteristic data in which differences in marking distribution characteristics caused due to a difference in marking features from other users are reduced.

Therefore, the second marking distribution characteristic data of users who are interested in the same part of book but are different in the distribution of the marking frequency due to a difference in marking features are generated so as to absorb the difference in marking features and exhibit the similar marking distribution characteristics.

A marking data update process in the marking analysis system 1 according to the second embodiment is the same as the marking data update process in the marking analysis system 1 according to the first embodiment described above with reference to FIG. 4, and the description thereof is omitted.

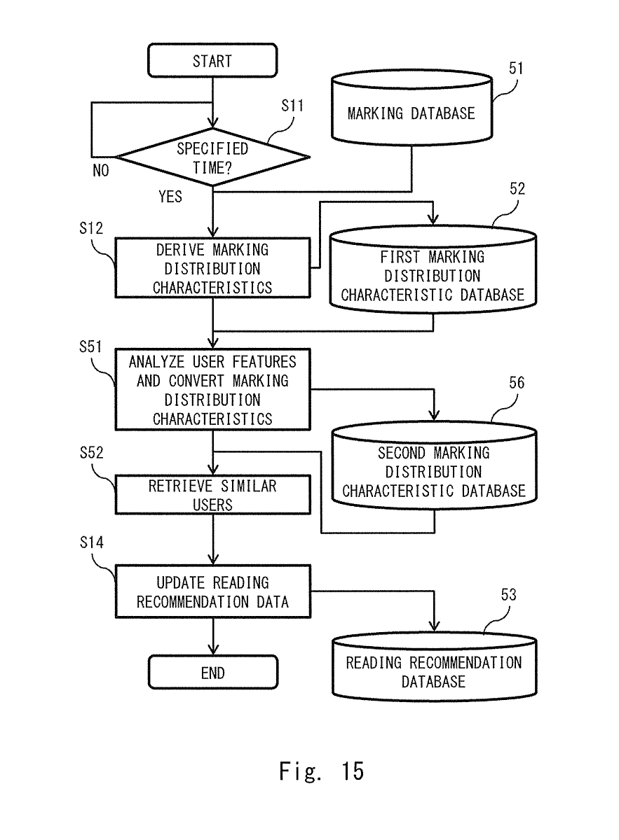

A data analysis process in the marking analysis system 1 according to the second embodiment is described hereinafter with reference to FIG. 15. The data analysis process according to the second embodiment is different from the process of data analysis according to the first embodiment described above with reference to FIG. 6 in that it includes the step S52 in place of the step S13 and further includes the step S51 between the step S12 and the step S52.

The user feature analysis unit 45 analyzes the plurality of first marking distribution characteristic data that constitute the first marking distribution characteristic database 52, and derives a plurality of second marking distribution characteristics, each corresponding to a pair of each of all users and each of all books. The user feature analysis unit 45 generates a plurality of second marking distribution characteristic data respectively indicating the plurality of derived second marking distribution characteristics, and updates the second marking distribution characteristic database 56 (S51). In other words, all of the second marking distribution characteristic data, each corresponding to a pair of each of all users and each of all books, are updated.

Then, in the second embodiment, the similar user retrieval unit 43 retrieves similar users based on a plurality of second marking distribution characteristic data that constitute the second marking distribution characteristic database 56 instead of a plurality of first marking distribution characteristic data that constitute the first marking distribution characteristic database 52. Specifically, the similar user retrieval unit 43 compares a plurality of marking distribution characteristics indicated by the plurality of second marking distribution characteristic data that constitute the second marking distribution characteristic database 56 with each other, and retrieves similar users who are similar in the marking distribution characteristics for each of all users (S52).

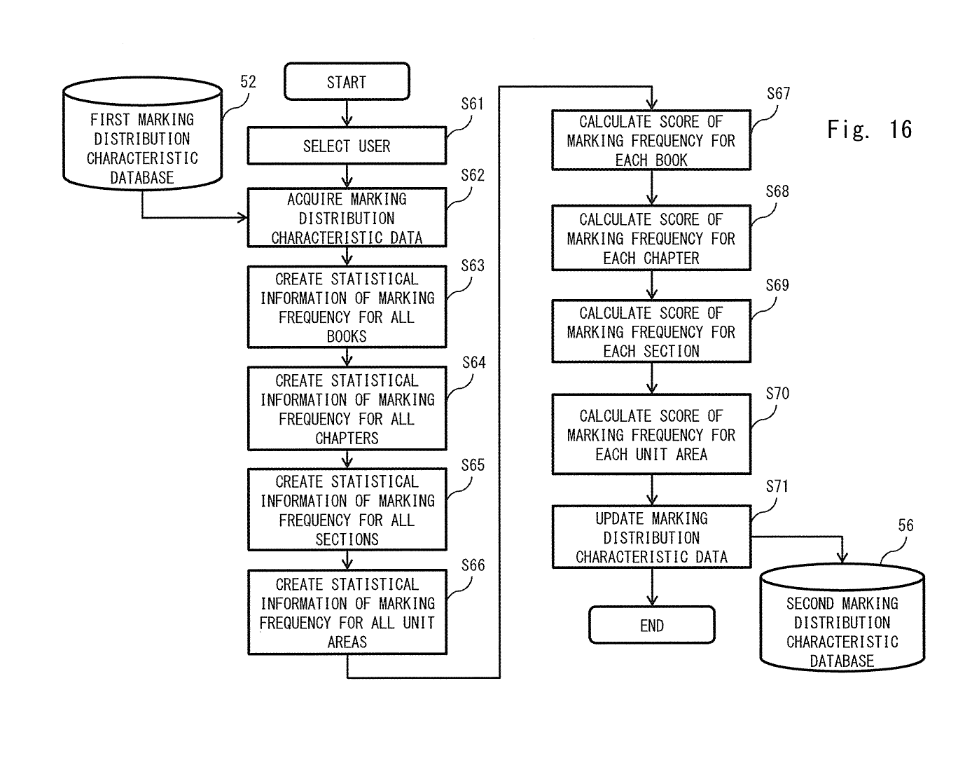

A user feature analysis process (S51) in the marking analysis system 1 according to the second embodiment is described hereinafter with reference to FIG. 16. Note that this process is performed for each of all users. Specifically, this process is performed by selecting all users in turn. Hereinafter, a user selected as a target to analyze the user feature is referred to also as “target user”.

The user feature analysis unit 45 selects a target user (S61). The user feature analysis unit 45 acquires a plurality of first marking distribution characteristic data corresponding to the target user from the first marking distribution characteristic database 52 (S62).

The user feature analysis unit 45 generates statistical information concerning books based on the distribution of the marking frequency indicated by the plurality of acquired first marking distribution characteristic data (S63). To be specific, as statistical information concerning books, information indicating the mean and the variance of the marking frequencies in units of all books which are calculated for all books is generated.

The user feature analysis unit 45 generates statistical information concerning chapters based on the distribution of the marking frequency indicated by the plurality of acquired first marking distribution characteristic data (S64). To be specific, as statistical information concerning chapters, information indicating the mean and the variance of the marking frequencies in units of all chapters which are calculated for all books is generated.

The user feature analysis unit 45 generates statistical information concerning sections based on the distribution of the marking frequency indicated by the plurality of acquired first marking distribution characteristic data (S65). To be specific, as statistical information concerning sections, information indicating the mean and the variance of the marking frequencies in units of all sections which are calculated for all books is generated.

The user feature analysis unit 45 generates statistical information concerning unit areas based on the distribution of the marking frequency indicated by the plurality of acquired first marking distribution characteristic data (S66). To be specific, as statistical information concerning unit areas, information indicating the mean and the variance of the marking frequencies in units of all unit areas in all books is generated.

As a calculation method of the marking frequency in each of books, chapters and sections, the sum or the mean of the marking frequencies in a unit area may be calculated for each of books, chapters and sections as described in the first embodiment.

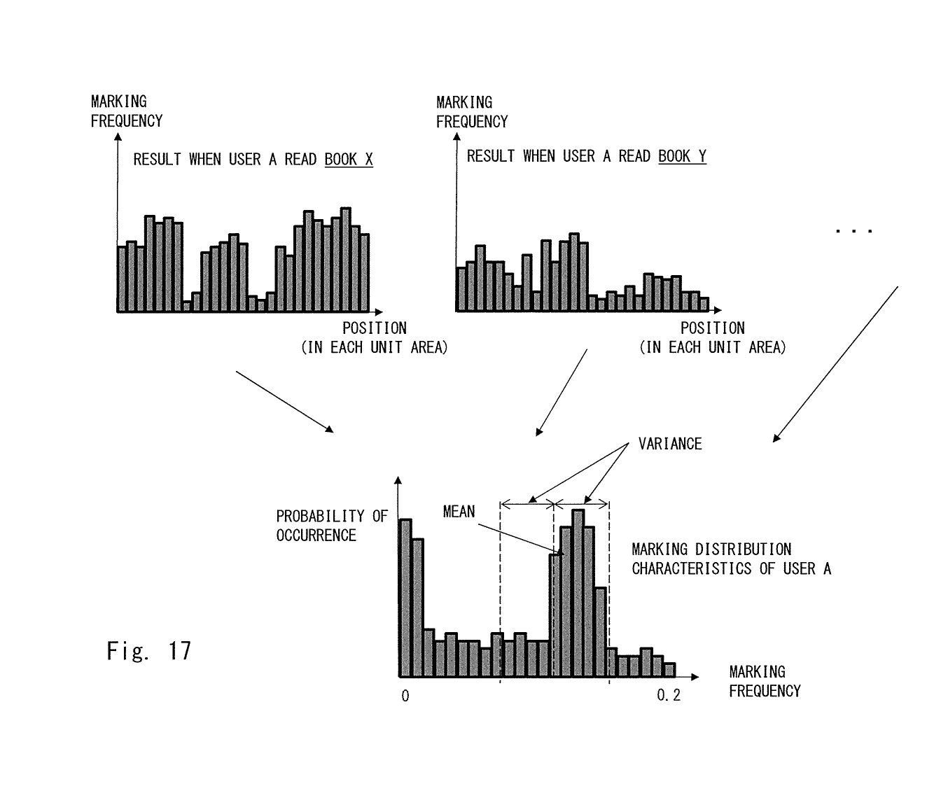

The statistical information is described hereinafter with reference to FIG. 17. Note that FIG. 17 shows, as a typical example, an image of statistical information concerning unit areas. As shown in FIG. 17, it is assumed that a histogram showing the probability of occurrence (the number of occurrences) of the marking frequency in a unit area in a plurality of books is generated for each of different marking frequencies. In this case, the mean and the variance as shown in FIG. 17 are calculated.

Based on the generated statistical information, the user feature analysis unit 45 calculates the score of the marking frequency of each book for each of the marking frequencies in each book calculated for a plurality of books (S67). To be specific, as this score, a deviation of the marking frequency in each book is calculated for each of a plurality of books based on the mean and the variance indicated by the statistical information corresponding to the book.

Based on the generated statistical information, the user feature analysis unit 45 calculates the score of the marking frequency of each chapter for each of the marking frequencies in each chapter calculated for a plurality of books (S68). To be specific, as this score, a deviation of the marking frequency in each chapter is calculated for each of a plurality of chapters in a plurality of books based on the mean and the variance indicated by the statistical information corresponding to the chapter.

Based on the generated statistical information, the user feature analysis unit 45 calculates the score of the marking frequency of each section for each of the marking frequencies in each section calculated for a plurality of books (S69). To be specific, as this score, a deviation of the marking frequency in each section is calculated for each of a plurality of sections in a plurality of books based on the mean and the variance indicated by the statistical information corresponding to the section.

Based on the generated statistical information, the user feature analysis unit 45 calculates the score of the marking frequency of each unit area for each of the marking frequencies in each unit area calculated for a plurality of books (S70). To be specific, as this score, a deviation of the marking frequency in each unit area is calculated for each of a plurality of unit areas in a plurality of books based on the mean and the variance indicated by the statistical information corresponding to the unit area.

The deviation is calculated by the following equation

Sᵢ=10(Xᵢ−μ)/σ+50 (1)

Sᵢ is the score in the i-th book, chapter, section or unit area.

Xᵢ is the marking frequency in the i-th book, chapter, section or unit area.

μ is the mean of the marking frequencies in each book, chapter, section or unit area.

σ is the variance of the marking frequencies in each book, chapter, section or unit area.

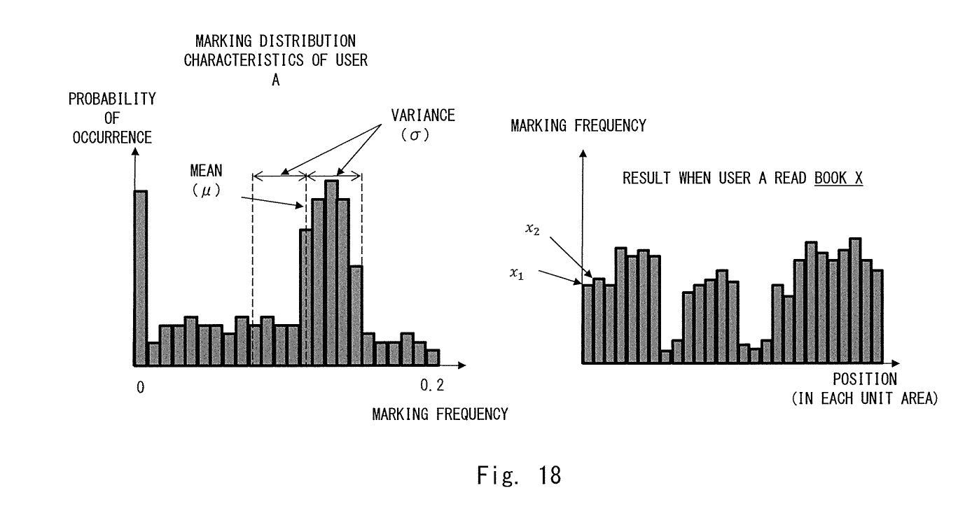

The deviation of the marking frequency is described hereinafter with reference to FIG. 18. FIG. 18 shows, as a typical example, the relationship of the parameters in the above equation (1) in the case of calculating the deviation in each unit area.

When calculating the deviation in each unit area, the deviation is calculated for each of the cases where “i” is “1” to “the total number of unit areas of all books” according to the above equation (1). Thus, when each of a plurality of unit areas in a book X is assigned to “i” that is “1” to “the number of unit areas in the book X”, X₁ is the marking frequency in the first unit area of the book X, and X₂ is the marking frequency in the second unit area of the book X as shown in FIG. 18.

Note that, when calculating the deviation in each book, the deviation is calculated for each of the cases where “i” is “1” to “the total number of books” using the above equation (1). When calculating the deviation in each chapter, the deviation is calculated for each of the cases where “i” is “1” to “the total number of chapters in all books” using the above equation (1). When calculating the deviation in each section, the deviation is calculated for each of the cases where “i” is “1” to “the total number of sections in all books” using the above equation (1).

Then, the user feature analysis unit 45 generates, for the target user, the second marking distribution characteristic data indicating the score in each book, the score in each chapter, the score in each section, and the score in each unit area calculated as above, and updates the second marking distribution characteristic database 56 (S71). In other words, the second marking distribution characteristic data each corresponding to a pair of the target user and each of all books is updated in the second marking distribution characteristic database 56.

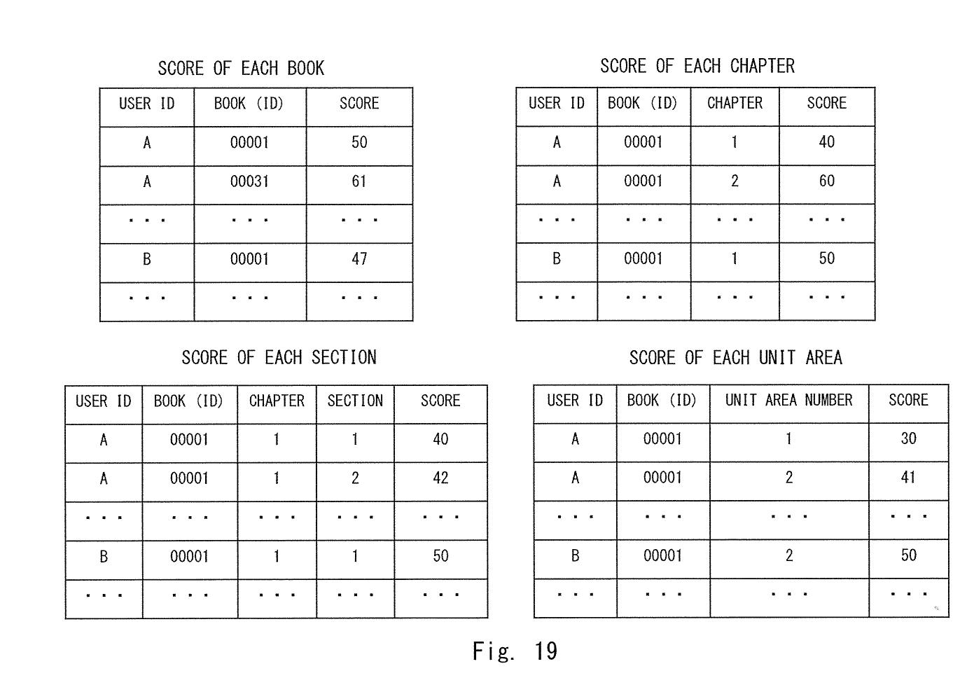

A specific example of the second marking distribution characteristic database 56 is described hereinafter with reference to FIG. 19. As shown in FIG. 19, the second marking distribution characteristic database 56 contains book score information indicating a plurality of scores of books, chapter score information indicating a plurality of scores of chapters, section score information indicating a plurality of scores of sections, and unit area score information indicating a plurality of scores of unit areas.

The book score information contains a plurality of information indicating a user identifier, a book identifier, and a score in the book identified by the book identifier. The chapter score information contains a plurality of information indicating a user identifier, a book identifier, a chapter number in the book identified by the book identifier, and a score in the chapter identified by the chapter number. The section score information contains a plurality of information indicating a user identifier, a book identifier, a chapter number in the book identified by the book identifier, a section number in the chapter indicated by the chapter number, and a score in the section identified by the section number. The unit area score information contains a plurality of information indicating a user identifier, a book identifier, a unit area number in the book identified by the book identifier, and a score in the unit area identified by the unit area number. Note that FIG. 19 shows an example of using a user ID as the user identifier and using a book ID as the book identifier. Specifically, the second marking distribution characteristic data corresponding to a pair of a certain user and a certain book, out of a plurality of second marking distribution characteristic data that constitute the second marking distribution characteristic database 56, contains information indicating the user identifier of the user and the book identifier of the book among the information contained in each of the book score information, the chapter score information, the section score information and the unit area score information.

As shown in FIG. 19, information about books which the target user has not read may be excluded from the score information (the book score information, the chapter score information, the section score information and the unit area score information). For example, when the marking frequency of all unit areas indicated by the first marking distribution characteristic data corresponding to a certain book is a default value (for example, “0”), the user feature analysis unit 45 may refrain from using the marking frequency concerning the first marking distribution characteristic data for the calculation of statistical information and may refrain from adding information about the first marking distribution characteristic data to the score information.

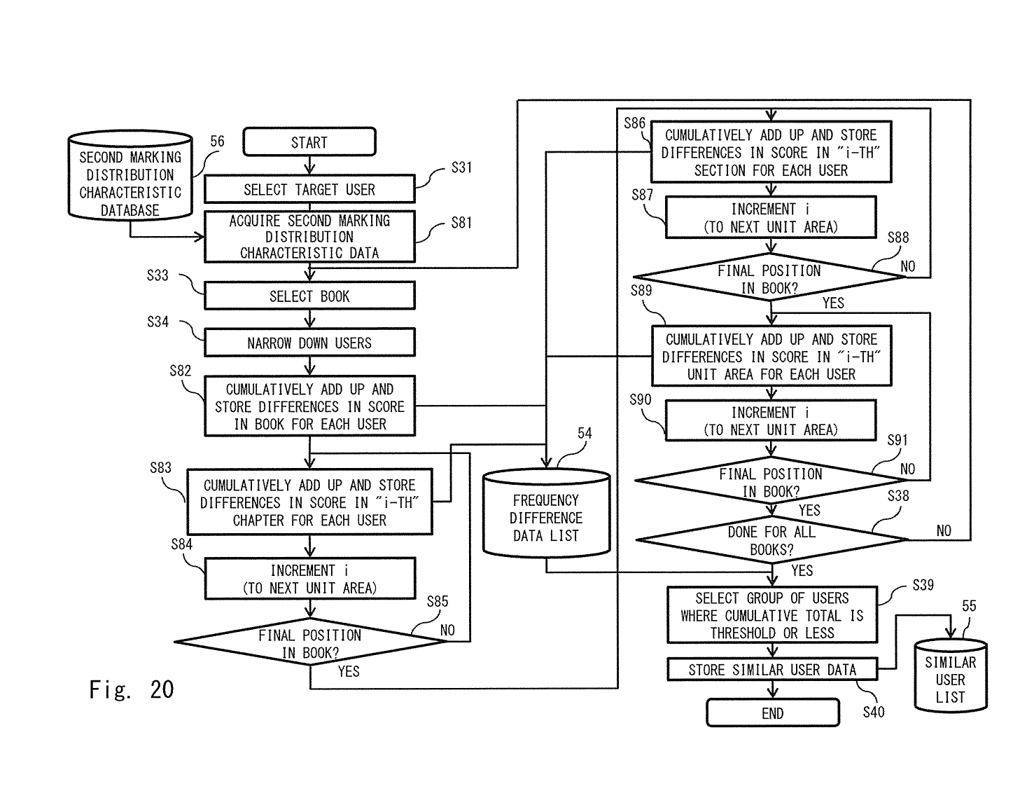

A similar user search process (S52) in the marking analysis system 1 according to the second embodiment is described hereinafter with reference to FIG. 20. Note that this process is performed for each of all users. Specifically, this process is performed by selecting all users in turn. Hereinafter, a user selected as a target to analyze the similar user is referred to also as “target user”.

The similar user search process (S52) in the marking analysis system 1 according to the second embodiment is different from the similar user search process (S13) in the marking analysis system 1 according to the first embodiment described earlier with reference to FIG. 11 in that it includes the step S81 in place of the step S32 and further includes the steps S82 to S91 instead of the steps S35 to S37.

After selecting a target user (S31), the similar user retrieval unit 43 acquires a plurality of second marking distribution characteristic data corresponding to the target user from the second marking distribution characteristic database 56 (S81).

After specifying other users who have placed marking on the same book as the book selected in the step S33 (S34), the similar user retrieval unit 43 calculates, for the book selected in the step S33, a difference in the score of each book between the target user and each of the other users specified in the step S34, and calculates the cumulative total of the calculated differences for each of the other users specified in the step S34. Note that, for the book selected for the first time, the calculated difference is used as the cumulative total without any addition. On the other hand, for the book selected for the second time and later, a value obtained by adding the calculated difference to the cumulative total is used as a new cumulative total.

The similar user retrieval unit 43 calculates, for the book selected in the step S33, a difference between the score in the “i-th” chapter of the target user and the score in the “i-th” chapter of each of the other users specified in the step S34, and calculates the cumulative total of the calculated differences for each of the other users specified in the step S34. Note that “i” starts with “1”.

In other words, the similar user retrieval unit 43 calculates a value obtained by adding the calculated difference to the cumulative total as a new cumulative total. The similar user retrieval unit 43 updates the cumulative total for the target user and each of the other users specified in the step S34 to the calculated cumulative total in the frequency difference data list 54 (S83).

The similar user retrieval unit 43 then increments i (S84). Stated differently, the marking distribution analysis unit 42 sets the next chapter as a processing target. The similar user retrieval unit 43 determines whether the final position of the book is reached or not (S85). Specifically, when the chapter before the increment is the final chapter, the marking distribution analysis unit 42 determines that the final position of the book is reached and, otherwise, determines that the final position of the book is not yet reached. In other words, when “i” reaches “the number of chapters in the book selected in Step S33 +1”, it is determined that the final position of the book is reached.

When it is determined that the final position of the book is not reached (No in S85), the similar user retrieval unit 43 performs the process from the step S83 for the next chapter. On the other hand, when it is determined that the final position of the book is reached (Yes in S85), the similar user retrieval unit 43 calculates, for the book selected in the step S33, a difference between the score in the “i-th” section of the target user and the score in the “i-th” section of each of the other users specified in the step S34, and calculates the cumulative total of the calculated differences for each of the other users specified in the step S34. Note that “i” starts with “1”.

In other words, the similar user retrieval unit 43 calculates a value obtained by adding the calculated difference to the cumulative total as a new cumulative total. The similar user retrieval unit 43 updates the cumulative total for the target user and each of the other users specified in the step S34 to the calculated cumulative total in the frequency difference data list 54 (S86).

The similar user retrieval unit 43 then increments i (S87). Stated differently, the marking distribution analysis unit 42 sets the next section as a processing target. The similar user retrieval unit 43 determines whether the final position of the book is reached or not (S88). Specifically, when the section before the increment is the final section, the marking distribution analysis unit 42 determines that the final position of the book is reached and, otherwise, determines that the final position of the book is not yet reached. In other words, when “i” reaches “the number of chapters in the book selected in Step S33 +1”, it is determined that the final position of the book is reached.

When it is determined that the final position of the book is not reached (No in S88), the similar user retrieval unit 43 performs the process from the step S86 for the next section. On the other hand, when it is determined that the final position of the book is reached (Yes in S88), the similar user retrieval unit 43 calculates, for the book selected in the step S33, a difference between the score in the “i-th” unit area of the target user and the score in the “i-th” unit area of each of the other users specified in the step S34, and calculates the cumulative total of the calculated differences for each of the other users specified in the step S34. Note that “i” starts with “1”.

In other words, the similar user retrieval unit 43 calculates a value obtained by adding the calculated difference to the cumulative total as a new cumulative total. The similar user retrieval unit 43 updates the cumulative total for the target user and each of the other users specified in the step S34 to the calculated cumulative total in the frequency difference data list 54 (S89).

The similar user retrieval unit 43 then increments i (S90). Stated differently, the marking distribution analysis unit 42 sets the next unit area as a processing target. The similar user retrieval unit 43 determines whether the final position of the book is reached or not (S91). A method of this determination is the same as in the above Step S26.

The frequency difference data list 54 according to the second embodiment is the same as the frequency difference data list 54 according to the first embodiment except that it contains the cumulative total of differences in the score on the basis of the marking frequency, not in the marking frequency.

Accordingly, the process after the step S39 is the same as that in the first embodiment except that the threshold used in the step S39 is not for the marking frequency but for the score, and the redundant description is omitted.

Note that, although an example where the score is calculated for each book, chapter, section and unit area is described above, it is not limited thereto. For example, the score may be calculated for any unit selected from each book, chapter, section and unit area. For example, the score may be calculated only for each unit area, just like the first marking distribution characteristic data.

Further, although, in the above description, it is determined that a target user and another user are similar when the cumulative total of differences in the score of a specified unit (book, chapter, section, unit area) between the target user and other users is equal to or less than a threshold for all books read by the target user, it is not limited thereto. For example, it may be determined that a target user and another user are similar when the mean of differences in the score of a specified unit between the target user and other users is equal to or less than a threshold for all books read by the target user.

For example, the cumulative total of differences in the score may be calculated for each book, not for all books read by the target user, and when the cumulative total of differences in the score of a specified unit between the target user and another user is equal to or less than a threshold for at least any one of them, it may be determined that the target user and another user are similar. Further, for example, the mean of differences in the score may be calculated for each book, and when the mean of differences in the score of a specified unit between the target user and another user is equal to or less than a threshold for at least any one of them, it may be determined that the target user and another user are similar.

Note that, although an example of calculating the total (cumulative total) or the arithmetic mean (mean) of differences in the score in each book, chapter, section and unit area is described above, it is not limited thereto. The cumulative total or the mean may be calculated by adding up differences in the score after multiplying them by weights that are different among book, chapter, section and unit area. Specifically, the weighted sum and the weighted mean of differences in the score may be calculated, and when the calculated weighted sum or weighted mean is equal to or less than a specified threshold, it may be determined that the target user and another user are similar.

A reading recommendation data generation process in the marking analysis system 1 according to the second embodiment is the same as the reading recommendation data generation process in the marking analysis system 1 according to the first embodiment described earlier with reference to FIG. 12 and is not redundantly described below.

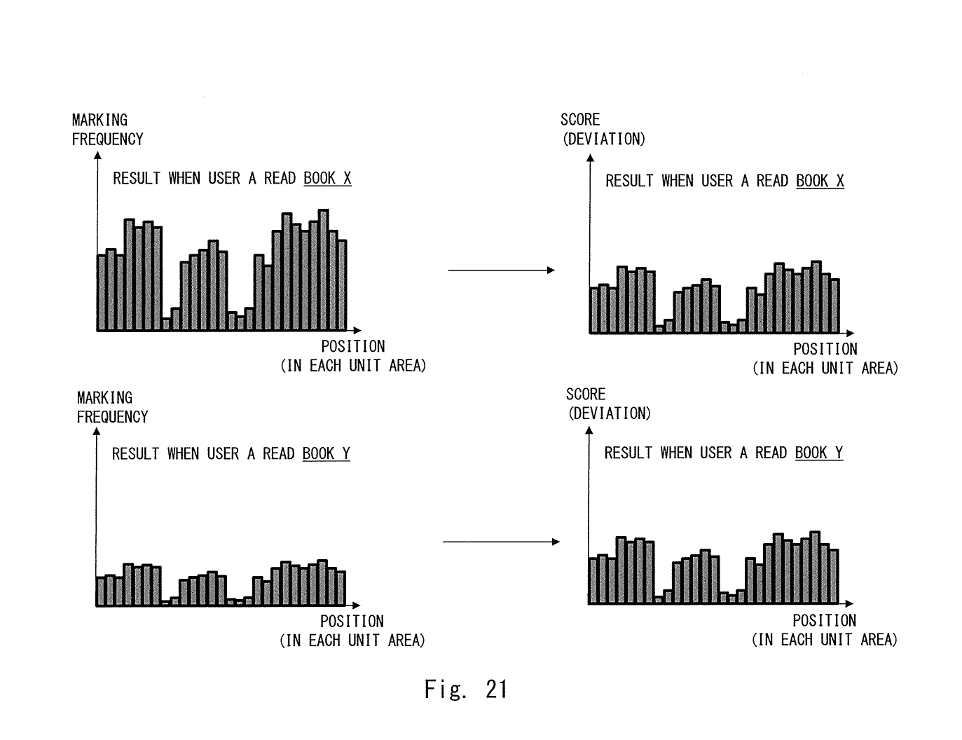

Effects of the second embodiment are described with reference to FIG. 21. FIG. 21 shows, as a typical example, the marking distribution characteristics in unit areas out of the second marking distribution characteristic data. As described earlier, as the marking distribution characteristics to be used for the determination of similar users, the marking distribution characteristics where the distribution of the marking frequency is converted into the distribution of the deviation of the marking frequency are used. Specifically, the marking frequency in each specified unit (book, chapter, section and unit area) of a user is converted into the statistics indicating a deviation of the user's marking frequency from the mean, and the distribution of the statistics is used as the marking distribution characteristics to be used for the determination of similar users. In this manner, a similarity of the distribution of the marking frequency is determined based on a similarity of the distribution of the deviation of the marking frequency.

Therefore, even when the way of adding marking varies between users, such as users who place rather few markings as a whole and users who place rather many markings as a whole, it is corrected to a value on the basis of the usual marking frequency of each user as shown in FIG. 21. Therefore, users who have an interest in the similar part can obtain the similar marking distribution characteristics regardless of the way of adding marking. It is thereby possible to achieve the retrieval of similar users with significantly high accuracy.

Note that the statistics indicated by the second marking distribution characteristic data are not limited to the deviation as long as the similar effects can be obtained. For example, as the statistics indicating a deviation of the marking frequency from the mean, a result of adding a specified offset value to a value obtained by subtracting the mean of the marking frequencies in all specified units in a plurality of all books from the marking frequency in a specified unit (book, chapter, section, unit area) so that a value obtained finally becomes positive may be used.

As described above, in the second embodiment, the user feature analysis unit 45 calculates, for each of a plurality of unit areas, statistics indicating a deviation of the marking frequency in a unit area from the mean of the marking frequencies in the plurality of unit areas based on the first marking distribution characteristic data, and generates the second marking distribution characteristic data indicating the distribution of the calculated statistics. Then, when the distribution of the statistics indicated by the second marking distribution characteristic data generated from the first marking distribution characteristic data of the target user and the distribution of the statistics indicated by the second marking distribution characteristic data generated from the first marking distribution characteristic data of another user are similar, the similar user retrieval unit 43 determines that the distribution of the marking frequency is similar between them.

To be specific, in the second embodiment, based on the plurality of first marking distribution characteristic data generated for a user, the user feature analysis unit 45 generates, as the second marking distribution characteristic data for that user, data indicating the deviation of the marking frequency in each of a plurality of books, the deviation of the marking frequency in each of a plurality of chapters in a plurality of books, the deviation of the marking frequency in each of a plurality of sections in a plurality of books, and the deviation of the marking frequency in each of a plurality of unit areas. Then, the similar user retrieval unit 43 calculates differences between each of a plurality of deviations indicated by the second marking distribution characteristic data of the target user and each of a plurality of deviations indicated by the second marking distribution characteristic data of another user, and determines that the distribution of the marking frequency is similar when the total, the weighted sum, the arithmetic mean or the weighted mean of the calculated differences is equal to or less than a specified threshold.

In this embodiment, even when the way of adding marking varies between users, such as users who place rather few markings as a whole and users who place rather many markings as a whole, it is possible to obtain the similar marking distribution characteristics for a plurality of users who have an interest in the similar part regardless of the way of adding marking. It is thereby possible to achieve the retrieval of similar users with significantly high accuracy.

### Second Embodiment

A third embodiment is described hereinafter. In the following description, the same matter as in the first embodiment described above is denoted by the same reference symbol or the like, and the description thereof is omitted as appropriate. The schematic configuration and the detailed configuration of the marking analysis system 1 and the hardware configuration of the pen scanner 2 according to the third embodiment are the same as those according to the first embodiment and thus not redundantly described.

Note that, however, the marking analysis system 1 according to the third embodiment operates differently from the marking analysis system 1 according to the first embodiment in the following way.

The marked position specifying unit 41 according to the third embodiment is different from the marked position specifying unit 41 according to the first embodiment in that it further acquires a marking time of marking whose position is specified. Then, the marked position specifying unit 41 updates the marking data in the marking database 51 so as to additionally show a pair of the specified marked position and the marking time.

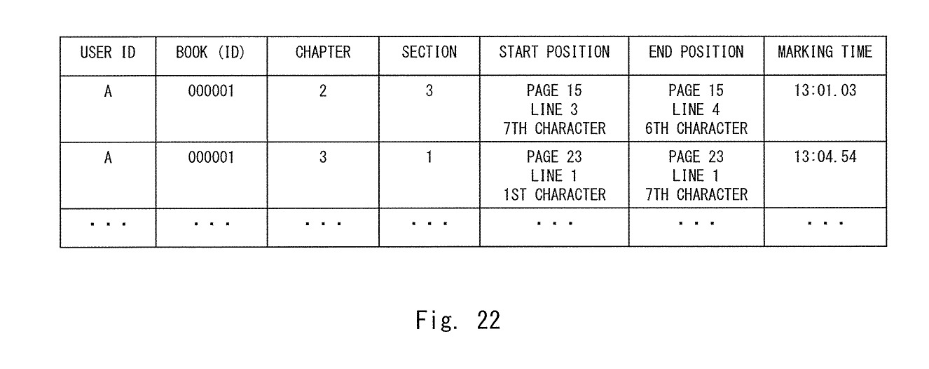

Specifically, in the third embodiment, as shown in FIG. 22, the marking database 51 contains a plurality of information indicating a user identifier, a book identifier, a chapter number, a section number, a start position (a page number, a line number and a character number), an end position (a page number, a line number and a character number), and a marking time.

As a method of acquiring a marking time, the following (1) or (2) may be employed.

(1) A Time when Marking Information is Received by the Server 4

In this method, the marked position specifying unit 41 treats a time when marking information is received by the server 4 as a marking time. Specifically, as described above, each time marking is placed, marking information concerning the marking is transmitted from the pen scanner 2 to the server 4. Thus, in this method, a time when marking information is received is regarded as a marking time.

(2) A Time when Marking is Added by the Pen Scanner 2

In this method, a time when marking information is generated in response to marking is treated as a marking time. When the MCU 13 of the pen scanner 2 generates marking information, it acquires a time and generates time information indicating the acquired time. Note that, as this time, the time counted by a timer (not shown) of the MCU may be acquired. Then, the MCU 13 of the pen scanner 2 associates the generated marking information and the time information and transmits them to the server 4 through the smartphone 3.

The marked position specifying unit 41 of the server 4 specifies the marked position based on the marking information received from the pen scanner 2 and further acquires the time indicated by the time information associated with the marking information as the marking time.

The marking distribution analysis unit 42 according to the third embodiment is different from the marking distribution analysis unit 42 according to the first embodiment in that it derives, as the marking distribution characteristics, the distribution of a pair of the marking frequency with respect to a position in a unit area and the reading speed, not the distribution of the marking frequency with respect to a position of a unit area.

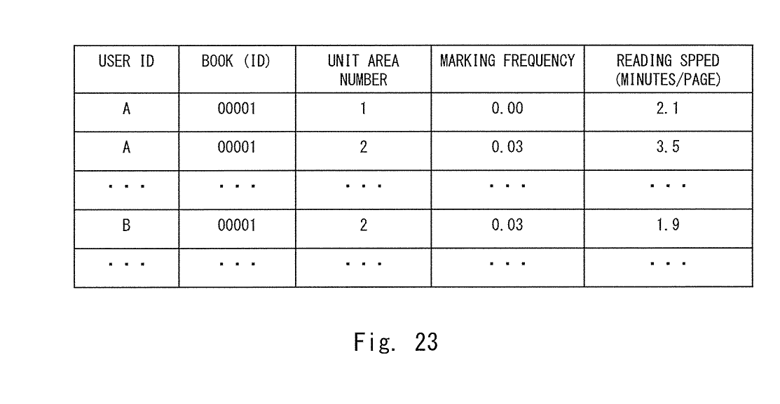

A specific example of the marking distribution characteristic database 52 according to the third embodiment is described hereinafter with reference to FIG. 23. As shown in FIG. 23, the marking distribution characteristic database 52 according to the third embodiment contains a plurality of information indicating a user identifier, a book identifier, a unit area number in the book identified by the book identifier, a marking frequency in the unit area indicated by the unit area number by the user identified by the user identifier, and a reading speed in the unit area by the user. Note that FIG. 23 shows an example where a user ID is used as the user identifier and a book ID is used as the book identifier.

The marking distribution analysis unit 42 may calculate, as the reading speed in a unit area, a difference between the marking time of the first marking in the unit area and the marking time of the first marking in a next unit area based on the marking data, for example. Further, in consideration of the case where marking is not placed in consecutive unit areas, the marking distribution analysis unit 42 may calculate, as the reading speed in a unit area, a difference between the marking time of the first marking in the unit area and the marking time of the first marking in a unit area with the smallest unit area number out of unit areas which come after this unit area and in which marking is placed.

Thus, the similar user retrieval unit 43 according to the third embodiment is different from the similar user retrieval unit 43 according to the first embodiment in that it compares the distribution of a pair of the marking frequency and the reading speed with each other, not the distribution of the marking frequency, and thereby extracts, as similar users, users who are similar in the distribution of a pair of the marking frequency and the reading speed for each of a plurality of users.

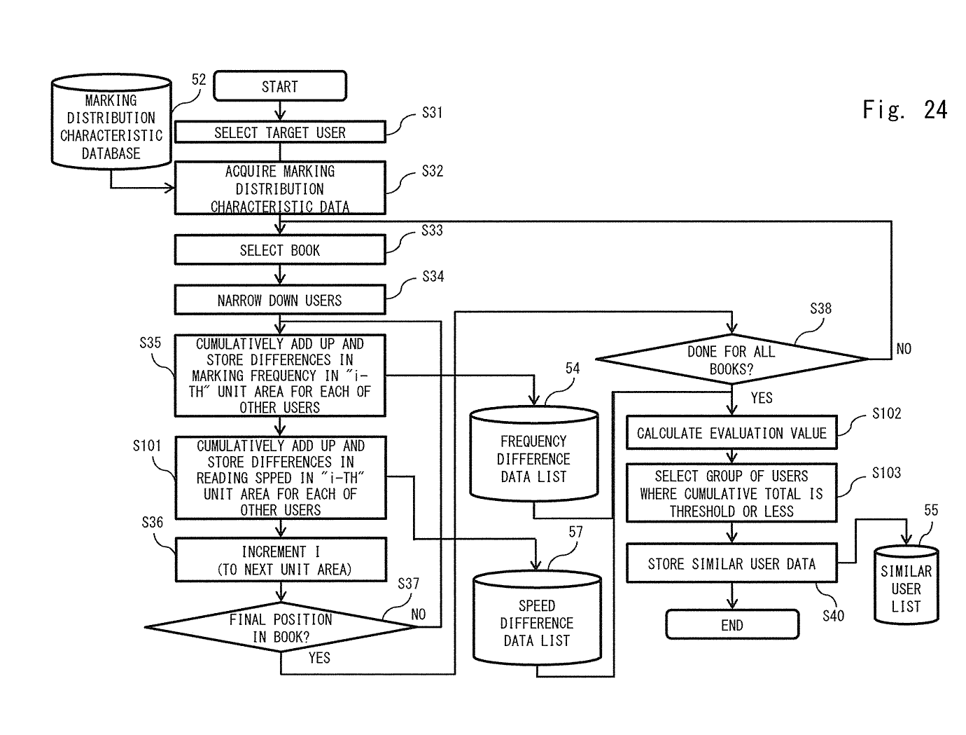

A similar user search process (S13) in the marking analysis system 1 according to the third embodiment is described hereinafter with reference to FIG. 24. Note that this process is performed for each of all users. Specifically, this process is performed by selecting all users in turn. Hereinafter, a user selected as a target to analyze similar users is referred to also as “target user”.

The similar user search process (S13) in the marking analysis system 1 according to the third embodiment is different from the similar user search process (S13) in the marking analysis system 1 according to the first embodiment in that it further includes the step S101 between the step S35 and the step S36 and includes the steps S102 and S103 instead of the step S39.

After calculating the cumulative total of the marking frequency in the “i-th” unit area (S35), the similar user retrieval unit 43 calculates a difference between the reading speed in the “i-th” unit area of the target user and the reading speed in the “i-th” unit area of each of the other users specified in the step S34, and calculates the cumulative total of the calculated differences for each of the other users specified in the step S34.

Specifically, when i=1, the similar user retrieval unit 43 uses the calculated difference as the cumulative total. When i≧2, the similar user retrieval unit 43 calculates a value obtained by adding the calculated difference to the cumulative total as a new cumulative total. The similar user retrieval unit 43 updates the cumulative total for each of pairs of the target user and each of the other users specified in Step S34 to the calculated cumulative total in a speed difference data list 57 (S101).

The speed difference data list 57 is composed of a plurality of cumulative totals concerning a reading speed. Each of the plurality of cumulative totals corresponds to each of possible pairs of two different users. Specifically, the cumulative total that corresponds to a pair of certain two users indicates the cumulative total of the differences in the reading speed between the unit areas indicated by the marking distribution characteristic data of the two users. The speed difference data list 57 is stored in the storage unit 40 of the server 4.

When the calculation of the cumulative total is done for all books read by the target user (Yes in S38), the similar user retrieval unit 43 calculates an evaluation value represented by the following equation (2) for each of the possible pairs of two different users.

Evaluation value=α×(cumulative total of differences in marking frequency)+β×(cumulative total of differences in reading speed)

α and β may be arbitrary values that are set in advance. The values of α and β may be different from each other. Specifically, when it is desirable that the determination about similar users is more strongly affected by the marking frequency than by the reading speed, α is set to be greater than β. On the other hand, when it is desirable that the determination about similar users is more strongly affected by the reading speed than by marking frequency, β is set to be greater than α. Thus, α and β may be set to equal values, and the total sum of differences in the marking frequency and differences in the reading speed may be used as the evaluation value, or α and β may be set to different values, and the weighted sum of differences in the marking frequency and differences in the reading speed may be used as the evaluation value.

The similar user retrieval unit 43 selects, from the users specified in the step S34, users whose evaluation value with the target user is equal to or less than a specified threshold as similar users (S103).

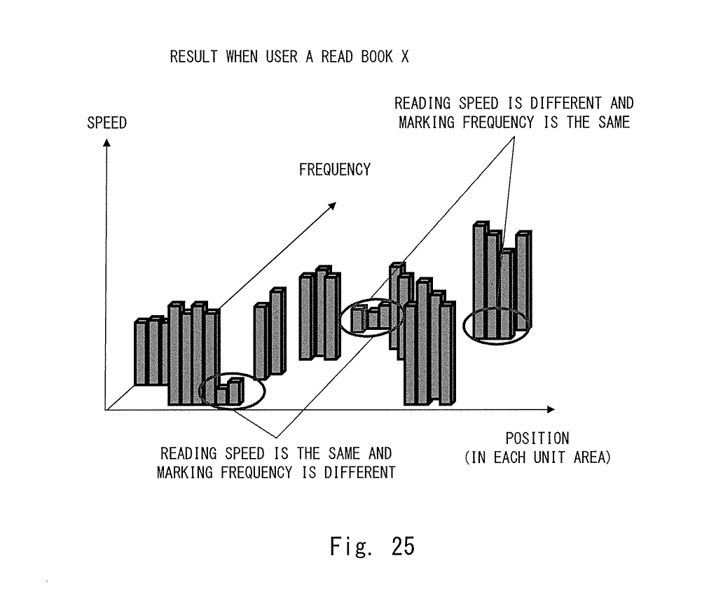

Effects of the third embodiment are described hereinafter with reference to FIG. 25. As described earlier, in the third embodiment, information that is taken into consideration when retrieving similar users is two dimensional (marking frequency+reading speed), rather than one dimensional (marking frequency). It is thereby possible to retrieve similar users more precisely. For example, as shown in FIG. 25, both of unit areas where the marking frequency is the same but the reading speed is different and unit areas where the reading speed is the same but the marking frequency is different can be detected as user features. Because the number of dimensions of information for the similar user analysis increases, it is possible to more precisely extract similar users.

Further, although it is determined that a target user and another user are similar when the evaluation value that is the sum of the cumulative total of differences in the marking frequency multiplied by a certain weight and the cumulative total of differences in the reading speed multiplied by a certain weight is equal to or less than a threshold in the above description, it is not limited thereto. For example, it may be determined that a target user and another user are similar when the evaluation value that is the sum of the mean of differences in the marking frequency multiplied by a certain weight and the mean of differences in the reading speed multiplied by a certain weight is equal to or less than a threshold.

Further, for example, the evaluation value may be calculated for each book, not for all books read by the target user, and when the evaluation value of the target user and another user is equal to or less than a threshold for at least any one of them, it may be determined that the target user and this another user are similar.

A reading recommendation data generation process (S14) in the marking analysis system 1 according to the third embodiment is substantially the same as the reading recommendation data generation process (S14) in the marking analysis system 1 according to the first embodiment described earlier with reference to FIG. 12 except for the following point.

In the step S44, a top specified number of books and parts in descending order of the marking frequency are derived in the first embodiment. On the other hand, in the third embodiment, a top specified number of books and parts in descending order of the evaluation value which is represented by the following equation (3) are derived.

Evaluation value=α×(marking frequency)+β×(1/reading speed) (3)

Note that “marking frequency” the above equation (3) corresponds to the marking frequency in each book, chapter, section and page described above. Further, “reading speed” in the above equation (3) corresponds to the reading speed in each book, chapter, section and page described above. The reading speed in each book, chapter, section and page can be calculated in the same way as the marking frequency in each book, chapter, section and page.

To be specific, the recommendation information generation unit 44 calculates, as the reading speed in each book, the sum or the mean of the reading speeds in all unit areas contained in the book, for each of the similar users. The recommendation information generation unit 44 calculates, as the reading speed in each chapter, the sum or the mean of the reading speeds in all unit areas contained in the chapter, for each of the similar users. The recommendation information generation unit 44 calculates, as the reading speed in each section, the sum or the mean of the reading speeds in all unit areas contained in the section, for each of the similar users. The recommendation information generation unit 44 calculates, as the reading speed in each page, the sum or the mean of the reading speeds in all unit areas contained in the page, for each of the similar users.

α and β may be arbitrary values that are set in advance. The values of α and β may be different from each other. Specifically, when it is desirable that the generation of reading recommendation data is more strongly affected by the marking frequency than by the reading speed, α is set to be greater than β. On the other hand, when it is desirable that the generation of reading recommendation data is more strongly affected by the reading speed than by marking frequency, β is set to be greater than α.

As described above, in the third embodiment, the marking distribution analysis unit 42 calculates the reading speed by a user for each of a plurality of unit areas based on the time indicated by the marking data, and generates, as the marking distribution characteristic data, data indicating the distribution of a pair of the reading speed and the marking frequency with respect to a position of a unit area. Then, the similar user retrieval unit 43 determines the similarity of the distribution of the pair of the reading speed and the marking frequency, as the similarity of the distribution of the marking frequency.

Because the number of dimensions of information for the similar user analysis increases, it is possible to more precisely extract similar users.

Further, as described above, in the third embodiment, the recommendation information generation unit 44 generates data indicating at least one of a top specified number of books in descending order of the weighted sum or the weighted mean of the marking frequencies and the inverse of the reading speeds of a plurality of similar users, and a top specified number of parts in descending order of the weighted sum or the weighted mean of the marking frequencies and the inverse of the reading speeds of a plurality of similar users in books to which the target user has not added any marking, as the reading recommendation data for the target user.

Because the number of dimensions of information for recommended books and parts for reading increases, a user can more precisely find a book or a part of a book to be read.

### Fourth Embodiment

A fourth embodiment is described hereinafter. In the following description, the same matter as in the first embodiment described above is denoted by the same reference symbol or the like, and the description thereof is omitted as appropriate. The schematic configuration of the marking analysis system 1 according to the fourth embodiment is the same as that according to the first embodiment and thus not redundantly described.

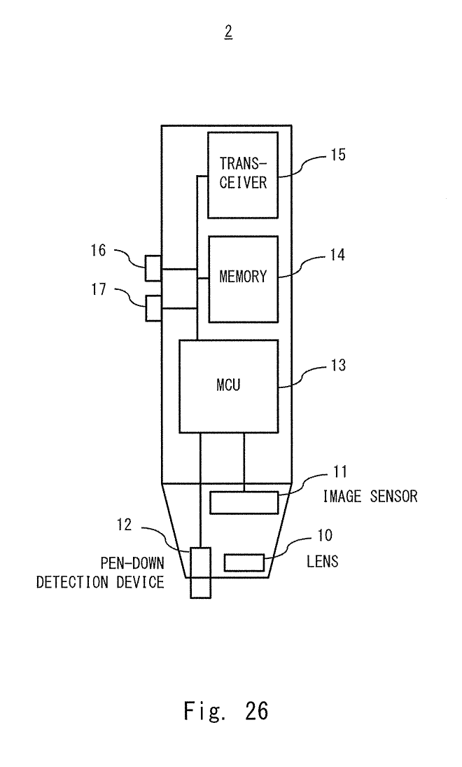

First, the hardware configuration of the pen scanner 2 according to the fourth embodiment is described with reference to FIG. 26. As shown in FIG. 26, the pen scanner 2 according to the fourth embodiment is different from the pen scanner 2 according to the first embodiment in that it further includes attribute designation buttons 16 and 17.

The attribute designation buttons 16 and 17 are buttons to designate the attribute of a part marked by a user. In the fourth embodiment, an example where the following patterns of attributes are designated is described.

(1) The attribute designation button 16 is ON, and the attribute designation button 17 is OFF

Attribute 1: The content of a marked part is understood.

(2) The attribute designation button 16 is OFF, and the attribute designation button 17 is OFF

Attribute 2: The content of a marked part is not understood.

(3) The attribute designation button 16 is OFF, and the attribute designation button 17 is ON

Attribute 3: The content of a marked part is interesting.

(4) The attribute designation button 16 is ON, the attribute designation button 17 is ON

Attribute 1+Attribute 3

The MCU 13 determines whether the attribute designation button 16 and the attribute designation button 17 are pressed before or during marking. According to a result of determination, the MCU 13 specifies the attribute of the marked part. Specifically, as described above, when the attribute designation button 17 remains OFF and the attribute designation button 16 is turned ON, the MCU 13 determines that the attribute of the marked part is “attribute 1”. When both of the attribute designation button 16 and the attribute designation button 17 remain OFF before or during marking, the MCU 13 determines that the attribute of the marked part is “attribute 2”. When the attribute designation button 16 remains OFF and the attribute designation button 17 is turned ON before or during marking, the MCU 13 determines that the attribute of the marked part is “attribute 3”. When both of the attribute designation button 16 and the attribute designation button 17 are turned ON before or during marking, the MCU 13 determines that the attribute of the marked part is “attribute 1”+“attribute 3”. Then, the MCU 13 generates attribute information indicating the determined attribute.

The MCU 13 associates the marking information generated in response to marking and the attribute information indicating the attribute of the marking, and transmits them to the server 4 through the smartphone 3. The server 4 can thereby acquire the attribute of the marking.

Note that, although an example where the number of attributes is three is described in the third embodiment, the number of attributes is not limited thereto. Specifically, the number of attribute designation buttons may be an arbitrary number which corresponds to the number of attributes defined. Further, the content of each attribute (the content of a marked part is understood etc.) is not limited to the above-described example.

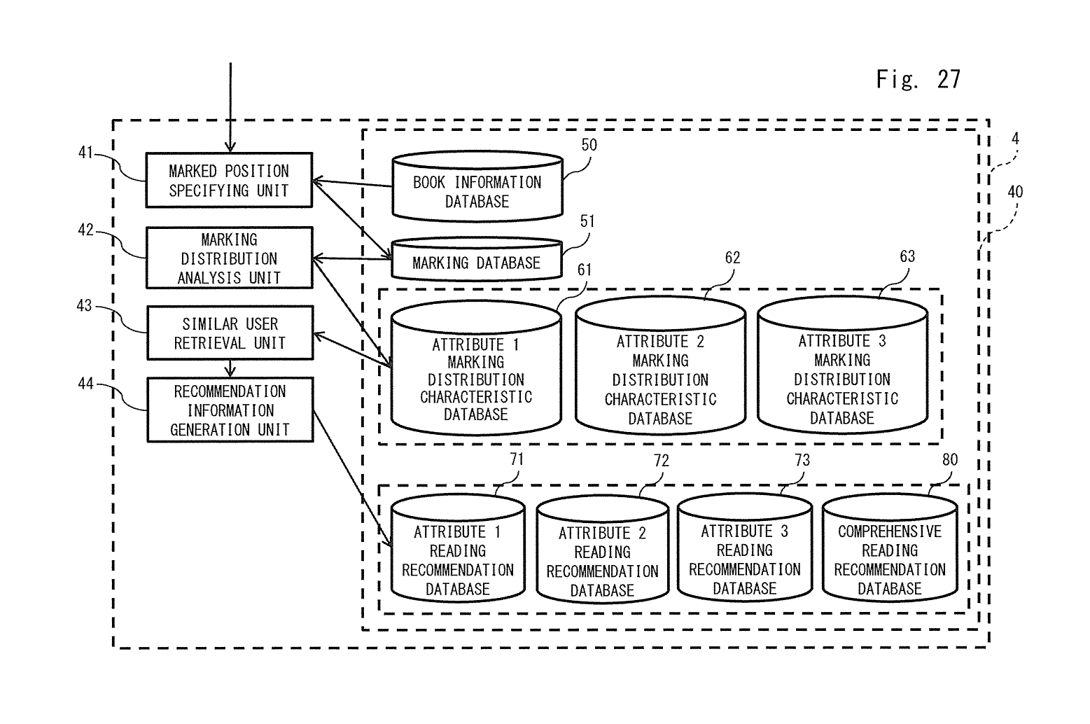

The detailed configurations of the pen scanner 2 and the smartphone 3 are the same as those described in the first embodiment, and not redundantly described. Hereinafter, the detailed configuration of the server 4 according to the fourth embodiment is described with reference to FIG. 27.

The marked position specifying unit 41 according to the fourth embodiment is different from the marked position specifying unit 41 according to the first embodiment in that it further acquires the attribute of marking whose marked position is specified. The marked position specifying unit 41 acquires, as the attribute of marking whose marked position is specified on the basis of the received marking information, an attribute indicated by attribute information associated with the marking information. Then, the marked position specifying unit 41 updates the marking data in the marking database 51 so as to additionally indicate a pair of the specified marked position and the acquired attribute.

Specifically, in the fourth embodiment, as shown in FIG. 27, the marking database 51 contains a plurality of information indicating a user identifier, a book identifier, a chapter number, a section number, a start position (a page number, a line number and a character number), an end position (a page number, a line number and a character number), and an attribute of the marked part in the marked position indicated by those book identifier, chapter number, section number, start position and end position.

Further, the server 4 according to the fourth embodiment is different from the server 4 according to the first embodiment in that marking distribution characteristic databases 61 to 63 respectively corresponding to different attributes are stored in the storage unit 40 instead of the marking distribution characteristic database 52, and reading recommendation databases 71 to 73 respectively corresponding to different attributes and a comprehensive reading recommendation database 80 are stored in the storage unit 40 instead of the reading recommendation database 53.

Specifically, the marking distribution analysis unit 42 according to the fourth embodiment generates the marking distribution characteristic data for each of different attributes. To be specific, the marking distribution analysis unit 42 generates a plurality of marking distribution characteristic data, each corresponding to a pair of each of a plurality of users and each of a plurality of books, based on a plurality of information indicating “attribute 1” among a plurality of information contained in the marking database 51, and updates the marking distribution characteristic database 61. The marking distribution analysis unit 42 generates a plurality of marking distribution characteristic data, each corresponding to a pair of each of a plurality of users and each of a plurality of books, based on a plurality of information indicating “attribute 2” among a plurality of information contained in the marking database 51, and updates the marking distribution characteristic database 62. The marking distribution analysis unit 42 generates a plurality of marking distribution characteristic data, each corresponding to a pair of each of a plurality of users and each of a plurality of books, based on a plurality of information indicating “attribute 3” among a plurality of information contained in the marking database 51, and updates the marking distribution characteristic database 63.

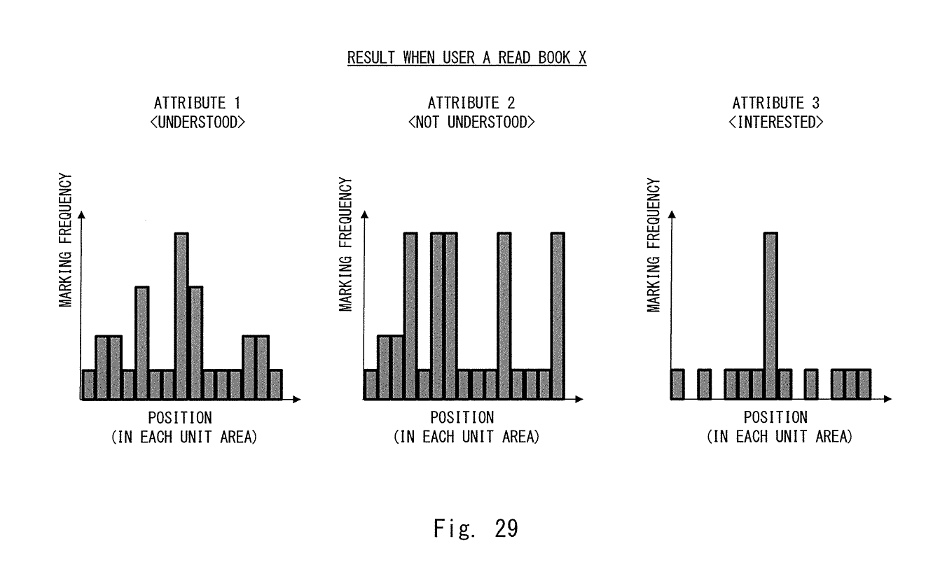

As a result, the distributions of the marking frequency respectively corresponding to “attribute 1” to “attribute 3” are derived as shown in FIG. 29. Note that, as shown in the example of the distributions of the marking frequency corresponding to “attribute 3”, when, in the distribution of the marking frequency of a certain attribute, there is a unit area where marking is not placed by designating that attribute, the marking frequency is a default value (for example, “0”).

The similar user retrieval unit 43 also generates similar user data for each of different attributes. Specifically, the similar user retrieval unit 43 generates the similar user data concerning “attribute 1” based on a plurality of marking distribution characteristic data that constitute the marking distribution characteristic database 61. The similar user retrieval unit 43 generates the similar user data concerning “attribute 2” based on a plurality of marking distribution characteristic data that constitute the marking distribution characteristic database 62. The similar user retrieval unit 43 generates the similar user data concerning “attribute 3” based on a plurality of marking distribution characteristic data that constitute the marking distribution characteristic database 63.

The recommendation information generation unit 44 also generates reading recommendation data for each of different attributes. Specifically, the recommendation information generation unit 44 generates the reading recommendation data concerning “attribute 1” based on a plurality of marking distribution characteristic data that constitute the marking distribution characteristic database 61, and updates the reading recommendation database 71. The recommendation information generation unit 44 generates the reading recommendation data concerning “attribute 2” based on a plurality of marking distribution characteristic data that constitute the marking distribution characteristic database 62, and updates the reading recommendation database 72. The recommendation information generation unit 44 generates the reading recommendation data concerning “attribute 3” based on a plurality of marking distribution characteristic data that constitute the marking distribution characteristic database 63, and updates the reading recommendation database 73.

Further, based on the reading recommendation data respectively corresponding to “attribute 1” to “attribute 3”, the recommendation information generation unit 44 generates comprehensive reading recommendation data indicating comprehensive recommended books for reading and recommended parts for reading, and updates the comprehensive reading recommendation database 80.

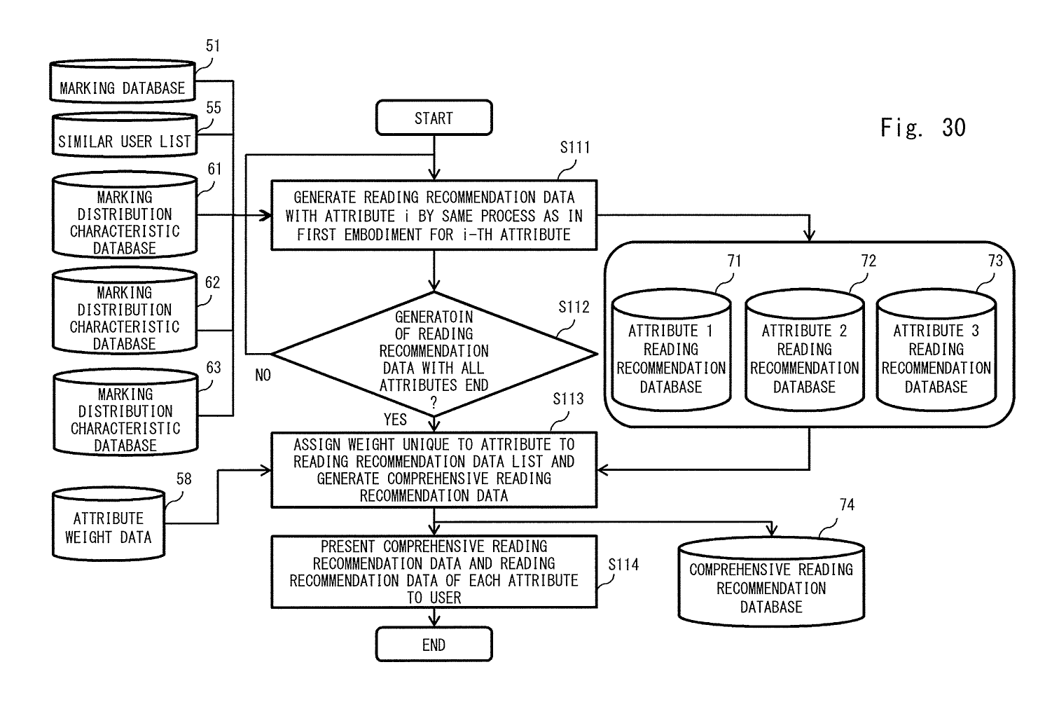

A reading recommendation data generation process (S14) in the marking analysis system 1 according to the fourth embodiment is described hereinafter with reference to FIG. 30. Note that this process is performed for each of all users. Specifically, this process is performed by selecting all users in turn. Hereinafter, a user selected as a target to analyze similar users is referred to also as “target user”.

The recommendation information generation unit 44 acquires a plurality of marking data corresponding to a target user from the marking database 51, acquires similar user data corresponding to the target user from the similar user list 55, and generates reading recommendation data corresponding to “attribute i” by a similar method to the reading recommendation data generation process according to the first embodiment described earlier with reference to FIG. 12. Specifically, the recommendation information generation unit 44 acquires a plurality of marking distribution characteristic data corresponding to “attribute i”, and generates the reading recommendation data corresponding to “attribute i” based on the plurality of acquired marking distribution characteristic data (S111).

After the generation of the reading recommendation data corresponding to “attribute i”, the recommendation information generation unit 44 determines whether the generation of reading recommendation data corresponding to all attributes is done or not (S112). When it determines that the generation of reading recommendation data corresponding to all attributes is not done (No in S112), the recommendation information generation unit 44 increments “i” and generates the reading recommendation data corresponding to the next “attribute i” (S111). In the example of the fourth embodiment, “i” starts with 1, and the maximum value of “i” is set to 3. Thus, the generation of the reading recommendation data is repeated until the reading recommendation data respectively corresponding to all attributes 1 to 3 are generated.

Thus, the recommendation information generation unit 44 first acquires a plurality of marking distribution characteristic data respectively corresponding to similar users of the target user from the marking distribution characteristic database 61 corresponding to “attribute 1”, and generates the reading recommendation data corresponding to “attribute i”. Next, the recommendation information generation unit 44 acquires a plurality of marking distribution characteristic data respectively corresponding to similar users of the target user from the marking distribution characteristic database 62 corresponding to “attribute 2”, and generates the reading recommendation data corresponding to “attribute 2”. The recommendation information generation unit 44 acquires a plurality of marking distribution characteristic data respectively corresponding to similar users of the target user from the marking distribution characteristic database 63 corresponding to “attribute 3”, and generates the reading recommendation data corresponding to “attribute 3”.

On the other hand, when the recommendation information generation unit 44 determines that the generation of reading recommendation data corresponding to all attributes is done (Yes in S112), it generates comprehensive reading recommendation data indicating comprehensive recommended books and parts for reading by assigning weights to each of books or parts indicated by the lists (the list of recommended books for reading, the list of recommended chapters for reading, the list of recommended sections for reading, and the list of recommended pages for reading) indicated by the reading recommendation data (S113).

To be specific, a score corresponding to ranking is assigned to each of books or parts indicated by each list. Then, the comprehensive reading recommendation data indicating a top specified number of (for example, top ten) books or parts in descending order of the total score that is the total of scores assigned to the same book or part in the reading recommendation data with the attribute 1 to the attribute 3 as the lists (the list of recommended books for reading, the list of recommended chapters for reading, the list of recommended sections for reading, and the list of recommended pages for reading).

The score of a book and a part can be calculated by the following equation (4).

$$\begin{matrix}{RScore}_{i} = {\sum }_{j = 1}^{n} {r}_{i , j} {α}_{j} & Λ\end{matrix} \qquad ( 4 )$$

“RScoreᵢ” is the score of the “i-th” book or part. Books or parts are sorted in descending order of the score and presented to a user as a list in the comprehensive reading recommendation data. Although the score may be calculated for all books or parts, it is calculated at least for all books or parts indicated by any of the lists. Thus, in the latter case, “i” is incremented from “1” to “the number of different books or parts indicated by each list”, and the scores of books or parts corresponding to “i” are calculated sequentially.

“r_{i,j}” is a weight corresponding to ranking in a list concerning the attribute j of the “i-th” book or part. As a weight corresponding to ranking, a score corresponding to ranking is assigned to each of books or parts. For example, 100 for the 1st in rank, 90 for the 2nd in rank, . . . , 10 for the 10th in rank, and 0 for those lower than the 10th in rank are assigned as the score. Specifically, a larger weight is assigned as it is ranked higher.

“αⱼ” is a weight when calculating the score of the attribute j. “αⱼ” is determined in advance for each attribute. For example, “α₁” is set to be greater than “α₂” and “α₃” to increase the effect of ranking on the reading recommendation data corresponding to “attribute 1”.

The calculation of scores and the generation of lists on the basis of ranking corresponding to scores are performed for each book, chapter, section and page, thereby generating comprehensive reading recommendation data indicating the generated lists and updating the comprehensive reading recommendation database 80.

Then, the recommendation information generation unit 44 presents the reading recommendation data corresponding to the generated comprehensive reading recommendation data and each attribute to the user (S114). To be specific, when a user refers to the reading recommendation data of him/herself, the user enters a request for display of the reading recommendation data to the input device of the smartphone 3. In response to the entering, a CPU of the smartphone 3 transmits request information that requests the reading recommendation data to the server 4. This request information indicates a user identifier of the user of the smartphone 3.

In response to receiving the request information from the smartphone 3, the recommendation information generation unit 44 of the server 4 acquires the reading recommendation data and the comprehensive reading recommendation data corresponding to each attribute of a user who is identified by the user identifier indicated by the request information from each of the reading recommendation databases 71, 72 and 73 and the comprehensive reading recommendation database 80, and transmits them to the smartphone 3.

In response to receiving the reading recommendation data, a CPU of the smartphone 3 displays the lists indicated by the received reading recommendation data on a display device of the smartphone 3. Note that the display device is a touch panel, for example.

The reading recommendation data that is presented to the user is not limited to all of the reading recommendation data corresponding to the respective attributes and the comprehensive reading recommendation data. For example, any one of the reading recommendation data corresponding to the attributes 1 to 3 may be presented.

As described above, in the fourth embodiment, the marking distribution analysis unit 42 generates the marking distribution characteristic data on the basis of positions to which the same attribute is assigned, and thereby generates the marking distribution characteristic data for each of different attributes. Then, the similar user retrieval unit 43 extracts similar users corresponding to the target user from the marking distribution characteristic data with the same attribute, and thereby extracts similar users corresponding to the target user for each of different attributes.

Because the number of dimensions for similar user analysis increases using information reflecting the user's intention, it is possible to more precisely extract similar users.

Further, as described above, in the fourth embodiment, the recommendation information generation unit 44 generates the reading recommendation data based on the marking distribution characteristic data with the same attribute, and thereby generates the reading recommendation data for each of different attributes.

In this embodiment, because the number of dimensions of information for recommended books and parts for reading increases, it is possible to more precisely find books or parts of books to be read by a user.

### Another Embodiment

Another embodiment is described hereinafter. Although the case where marking is added to a paper book is described in the first to fourth embodiments, it is not limited thereto. In another embodiment, marking may be added to an electronic book. This embodiment is described hereinafter as “alternative embodiment” below.

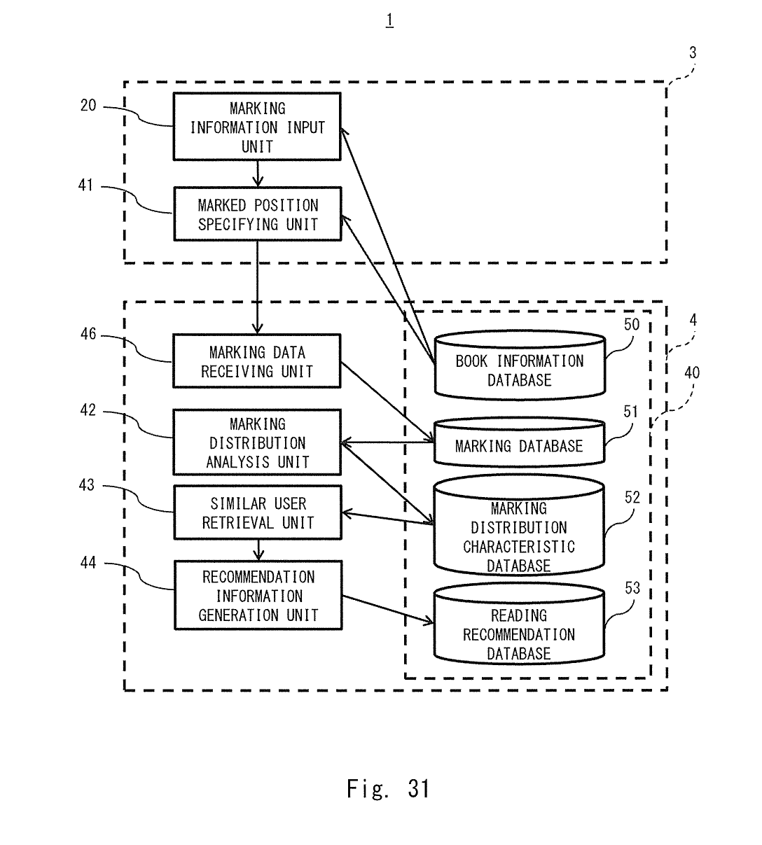

As shown in FIG. 31, the marking analysis system 1 according to an alternative embodiment is different from the marking analysis system 1 according to the first embodiment in that it does not include the pen scanner 2, a marking information input unit 20 is included in the smartphone 3, not in the pen scanner 2, a marked position specifying unit 41 is included in the smartphone 3, not in the server 4, and the server 4 further includes a marking data receiving unit 46.

In response to an input of a user's instruction to view an electronic book, the marking information input unit 20 downloads the electronic book designated by the user from the book information database 50 of the server 4.

The marking information input unit 20 treats a place where a user makes an input on an electronic book as a place where marking is added. For example, the marking information input unit 20 treats a place where a user slides the finger over the touch panel on an electronic book displayed on the touch panel, for example, as a place where marking is added. Further, in the case of using a PC, instead of the smartphone 3, as an information processing device that receives marking from a user, the marking information input unit 20 treats a place where an electronic book shown on a display is clicked and dragged with a mouse, for example, as a place where marking is added. Then, the marking information input unit 20 generates, as marking information, information indicating a place where marking is added.

As described in the above first to fourth embodiments, the marked position specifying unit 41 generates marking data based on the marking information generated by the marking information input unit 20 and transmits it to the server 4. The marking data receiving unit 46 of the server 4 receives the marking data from the smartphone 3 and updates the marking database 51 with the received marking data.

The above-described program can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

Although embodiments of the present invention are described specifically in the foregoing, the present invention is not restricted to the above-described embodiments, and various changes and modifications may be made without departing from the scope of the invention.

At least two of the first to forth embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A marking analysis system comprising:
a marking data storage unit to store a plurality of marking data indicating a plurality of positions marked by a user in a book so as to correspond respectively to a plurality of users;
a marking distribution analysis unit that analyzes the marking data stored in the marking data storage unit and calculates a marking frequency for each of a plurality of unit areas in the book, and generates marking distribution characteristic data indicating a distribution of the marking frequency with respect to a position in the unit area;
a marking distribution characteristic data storage unit to store the marking distribution characteristic data generated by the marking distribution analysis unit; and
a similar user retrieval unit that, when determining that the distribution of the marking frequency indicated by the marking distribution characteristic data of a target user selected as a processing target and the distribution of the marking frequency indicated by the marking distribution characteristic data of another user are similar, extracts the another user as a similar user who is similar to the target user.

2. The marking analysis system according to claim 1, wherein the similar user retrieval unit calculates a difference between the marking frequency of the target user and the marking frequency of another user for each of the plurality of unit areas, and determines that the distribution of the marking frequency is similar when a sum or a mean of calculated differences is equal to or less than a specified threshold.

3. The marking analysis system according to claim 2, wherein
in the marking data storage unit, the marking data is stored to correspond to each of the plurality of users and to each of a plurality of books, and
the similar user retrieval unit calculates, as the sum or the mean of differences, a sum or a mean of differences in the marking frequency calculated for each of the plurality of unit areas for each of the plurality of books.

4. The marking analysis system according to claim 1, wherein
in the marking data storage unit, the marking data is stored to correspond to each of the plurality of users and to each of a plurality of books, and
the marking analysis system further comprises a recommendation information generation unit that, based on a plurality of marking distribution characteristic data of similar users who are similar to a target user selected as a processing target, generates, as reading recommendation data for the target user, data indicating at least one of books to which the target user has not added any marking and similar users have added marking and marked parts in books to which the target user has not added any marking and similar users have added marking.

5. The marking analysis system according to claim 4, wherein the recommendation information generation unit generates, as the reading recommendation data, data indicating at least one of a top specified number of books in descending order of the marking frequency of each of a plurality of similar users who are similar to the target user and a top specified number of parts in the books in descending order of the marking frequency of each of the plurality of similar users.

6. The marking analysis system according to claim 1, further comprising:
a marking information input unit that receives an input of information about marking in the book by the user; and
a marked position specifying unit that specifies a position marked in the book based on the information input to the marking information input unit, and updates the marking data so as to indicate the specified position.

7. The marking analysis system according to claim 6, wherein
the book is a paper book,
the marking analysis system further comprises
a pen scanner including the marking information input unit, and
a server including the marked position specifying unit, the marking distribution analysis unit, the similar user retrieval unit, and an electronic book storage unit to store an electronic book being an electronic version of the paper book,
the pen scanner receives, as an input to add marking to the paper book, an operation of scanning the paper book, generates image information presenting an image of a character string scanned in the paper book, and transmits the image information to the server, and
the marked position specifying unit checks the character string presented by the image information received from the pen scanner against a character string shown in the electronic book, and thereby specifies the marked position.

8. The marking analysis system according to claim 1, wherein
the marking distribution characteristic data is first marking distribution characteristic data,
the marking analysis system further comprises a user feature analysis unit that calculates, for each of the plurality of unit areas, statistics indicating a deviation of the marking frequency in the unit area from the mean of the marking frequencies in the plurality of unit areas based on the first marking distribution characteristic data, and generates second marking distribution characteristic data indicating a distribution of the calculated statistics, and
when the distribution of the statistics indicated by the second marking distribution characteristic data generated from the first marking distribution characteristic data of the target user and the distribution of the statistics indicated by the second marking distribution characteristic data generated from the first marking distribution characteristic data of another user are similar, the similar user retrieval unit determines that the distribution of the marking frequency is similar.

9. The marking analysis system according to claim 8, wherein the similar user retrieval unit calculates a difference between the statistics of the target user and the statistics of another user for each of the plurality of unit areas, and determines that the distribution of the statistics is similar when a sum or a mean of the calculated differences is equal to or less than a specified threshold.

10. The marking analysis system according to claim 1, wherein
in the marking data storage unit, the marking data is stored to correspond to each of the plurality of users and to each of a plurality of books,
the marking distribution characteristic data is first marking distribution characteristic data,
the marking analysis system further comprises a user feature analysis unit that, based on a plurality of first marking distribution characteristic data generated for the user, generates, as second marking distribution characteristic data for that user, data indicating a deviation of the marking frequency in each of a plurality of books, a deviation of the marking frequency in each of a plurality of chapters in the plurality of books, a deviation of the marking frequency in each of a plurality of sections in the plurality of books, and a deviation of the marking frequency in each of a plurality of unit areas, and
the similar user retrieval unit calculates differences between each of a plurality of deviations indicated by the second marking distribution characteristic data of the target user and each of a plurality of deviations indicated by the second marking distribution characteristic data of another user, and determines that the distribution of the marking frequency is similar when a sum, a weighted sum, an arithmetic mean or a weighted mean of the calculated differences is equal to or less than a specified threshold.

11. The marking analysis system according to claim 1, wherein
the marking data further indicates a time when each of the plurality of positions is marked,
the marking distribution analysis unit calculates a reading speed of the user for each of the plurality of unit areas based on a time indicated by the marking data, and generates, as the marking distribution characteristic data, data indicating a distribution of a pair of the reading speed and the marking frequency with respect to a position in the unit area, and
the similar user retrieval unit determines a similarity of a distribution of a pair of the reading speed and the marking frequency as a similarity of the distribution of the marking frequency.

12. The marking analysis system according to claim 11, wherein the similar user retrieval unit calculates a difference between the marking frequency of the target user and the marking frequency of another user and a difference between the reading speed of the target user and the reading speed of another user for each of the plurality of unit areas, and determines that the distribution of a pair of the reading speed and the marking frequency is similar when a weighted sum or a weighted mean of a sum or a mean of the calculated differences in the marking frequency and a sum or a mean of the calculated differences in the reading speed is equal to or less than a specified threshold.

13. The marking analysis system according to claim 11, wherein
in the marking data storage unit, the marking data is stored to correspond to each of the plurality of users and to each of a plurality of books, and
the marking analysis system further comprises a recommendation information generation unit that, based on marking data generated for books to which the target user has not added any marking among a plurality of marking data of similar users who are similar to a target user selected as a processing target, generates data indicating at least one of a top specified number of books in descending order of a weighted sum or a weighted mean of the marking frequencies and the inverse of the reading speeds of the plurality of similar users, and a top specified number of parts in descending order of a weighted sum or a weighted mean of the marking frequencies and the inverse of the reading speeds of the plurality of similar users in the books to which the target user has not added any marking, as the reading recommendation data for the target user.

14. The marking analysis system according to claim 1, wherein
the marking data further indicates an attribute of a marked character string for each of the plurality of marked positions,
the marking distribution analysis unit generates the marking distribution characteristic data based on positions to which the same attribute is assigned and thereby generates the marking distribution characteristic data for each of different attributes, and
the similar user retrieval unit extracts similar users corresponding to the target user from the marking distribution characteristic data corresponding to the same attribute and thereby extracts similar users corresponding to the target user for each of different attributes.

15. The marking analysis system according to claim 14, further comprising:
a marking information input unit that receives an input of information about marking in the book by the user;
an attribute designation input unit that receives an input to designate an attribute of the information about marking in the book; and
a marked position specifying unit that specifies a position marked in the book based on the information input to the marking information input unit, and updates the marking data so as to indicate the specified position and the attribute designated by the input to the attribute designation input unit.

16. The marking analysis system according to claim 4, wherein
the marking data further indicates an attribute of a marked character string for each of the plurality of marked positions,
the marking distribution analysis unit generates the marking distribution characteristic data based on positions to which the same attribute is assigned and thereby generates the marking distribution characteristic data for each of different attributes,
the similar user retrieval unit extracts similar users corresponding to the target user from the marking distribution characteristic data corresponding to the same attribute and thereby extracts similar users corresponding to the target user for each of different attributes, and
the recommendation information generation unit generates the reading recommendation data based on the marking distribution characteristic data corresponding to the same attribute and thereby generates the reading recommendation data for each of different attributes.

17. The marking analysis system according to claim 16, wherein
the recommendation information generation unit generates, as the reading recommendation data, data indicating at least one of a top specified number of books in descending order of a sum of marking frequencies of a plurality of similar users who are similar to the target user and a top specified number of parts in the books in descending order of a sum of marking frequencies of the plurality of similar users for each of different attributes, and generates comprehensive reading recommendation data indicating at least one of a top specified number of books in descending order of a total of scores assigned, according to ranking, to the top specified number of books with all of different attributes and a top specified number of parts in descending order of a total of scores assigned, according to ranking, to the top specified number of parts with of all different attributes.

18. A marking analysis method comprising:
analyzing each of a plurality of marking data indicating a plurality of positions marked by a user in a book, the plurality of marking data corresponding respectively to a plurality of users, and calculating a marking frequency for each of a plurality of unit areas in the book, and generating marking distribution characteristic data indicating a distribution of the marking frequency with respect to a position in the unit area; and
when determining that a distribution of the marking frequency indicated by the marking distribution characteristic data of a target user selected as a processing target and a distribution of the marking frequency indicated by the marking distribution characteristic data of another user are similar, extracting the another user as a similar user who is similar to the target user.
